(19) United States
(12) Patent Application Publication
(10) Pub. No.: US 2011/0085432 A1
(43) Pub. Date: Apr. 14, 2011

(54) GRATING ELEMENT, OPTICAL PICKUP OPTICAL SYSTEM AND METHOD OF DESIGNING GRATING ELEMENT

(75) Inventors: Mitsuhiro Miyauchi, Ibaraki-shi (JP); Takako Shiba, Ibaraki-shi (JP); Takeshi Shimano, Ibaraki-shi (JP)

(73) Assignee: HITACHI MAXELL, LTD., Ibaraki-shi, Osaka (JP)

(21) Appl. No.: 12/995,761

(22) PCT Filed: Oct. 29, 2009
(86) PCT No.: PCT/JP2009/005734

§ 371 Date: Dec. 2, 2010

(30) Foreign Application Priority Data
Nov. 5, 2008 (JP) 2008-283995

(51) Int. Cl. G11B 7/135; G02B 5/18; B32B 37/02

(52) U.S. Cl. 369/112.04; 359/566; 156/60; G9B/7.113

(57) ABSTRACT

A grating element is provided with diffraction members wherein protrusions and recesses are periodically arranged, respectively, on one surface of each of transparent substrates. The diffraction members are laminated in the substantially perpendicular direction to the transparent substrates, the protrusions of the diffraction members are made of a dielectric multilayer film, and the dielectric multilayer film has dielectric films of two or more types laminated in the substantially perpendicular direction on the transparent substrates. The wavelengths of laser beams diffracted at predetermined diffraction efficiencies by the diffraction members are different from one another.

### TECHNICAL FIELD

The present invention relates to a grating element, an optical pickup optical system and a method of designing a grating element and, particularly, to a grating element which is used in an optical pickup optical system that focuses a plurality of laser beams with different wavelengths on an optical disc through a common optical path, the optical pickup optical system and a method of designing the grating element.

### BACKGROUND ART

Optical discs such as CD (Compact Disc), DVD (Digital Versatile Disc) and BD (Blu-ray (registered trademark) Disc) are widely used today. Those optical discs are of different generations, and an enormous amount of contents are accumulated in the respective generations. Further, the optical disc of the newer generation has a higher recording density, and a wavelength of a semiconductor laser is shorter. Therefore, an optical disc drive device that plays and records those optical discs generally includes a plurality of semiconductor laser light sources with different wavelengths. It is thereby possible to play and record an enormous amount of contents of the previous generation and contents of the next generation in one optical disc drive device. For example, a DVD drive is usually capable of playing CDs. Further, a BD drive is usually capable of playing DVDs and CDs.

As described above, the optical disc drive device that plays and records the optical discs of different generations includes a plurality of semiconductor laser light sources with different wavelengths. Therefore, it is necessary to arrange an optical path for each of the semiconductor laser light sources. This causes an increase in the number of parts and an increase in the size of the optical pickup optical system. In light of this, in order to prevent the increase in the number of parts and the increase in the size of the optical pickup optical system, a technique that focuses a plurality of laser beams emitted from a plurality of semiconductor laser light sources on an optical disc through a common optical path is under development. Particularly, in a slim optical disc drive called a slim drive or an ultra-slim drive that is mounted on a notebook computer, simplification of the optical system is essential. For example, a dual-wavelength semiconductor laser in which a red semiconductor laser for DVDs and an infrared semiconductor laser for CDs are integrated into one package is often used today.

On the other hand, the optical pickup optical system reproduces signals along with performing tracking control. Therefore, a laser beam emitted from a semiconductor laser light source is diffracted by a grating element to thereby generate the 0th order diffracted beam and the ±1st order diffracted beams. The 0th order diffracted beam is thereby focused and an optical spot for signal reproduction (which is referred to hereinafter as a main spot) is formed on an optical disc. Further, the ±1st order diffracted beams are focused and an optical spot for tracking signal generation (which is referred to hereinafter as a sub-spot) is formed on an optical disc. Then, a tracking signal is generated from the sub-spot. It is preferred that the interval, the intensity ratio and the relative position of the main spot and the sub-spot are appropriate values according to the groove shape or the track pitch of the optical discs of the respective generations. Therefore, it is necessary to use the grating element dedicated to the optical disc of each generation. It is thus necessary to use a plurality of grating elements for the respective laser light sources.

However, in the case of using the dual-wavelength semiconductor laser in which two semiconductor lasers with different wavelengths are integrated into one package as described above, the entire optical path from the laser to the optical disc is a common optical path. Therefore, the plurality of grating elements are placed on the common optical path. It is thus preferred that each grating element does not affect a laser beam with a wavelength different from a wavelength of a laser beam to be diffracted.

In view of the foregoing, Patent Literature 1 discloses a grating element in which a plurality of grooves are provided on both sides of a substrate. Further, the depth of the grooves provided on the surface of the grating element in Patent Literature 1 is a depth that causes a laser beam with a wavelength different from a wavelength of a laser beam to be diffracted to have a phase difference that is an integral multiple of the wavelength of the laser beam. Specifically, the surface of the grating element does not cause a phase shift of the laser beam with the wavelength different from the wavelength of the laser beam to be diffracted. On the other hand, the surface of the grating element causes the laser beam to be diffracted to have a phase difference that is not an integral multiple of the wavelength of the laser beam. Therefore, the surface of the grating element causes a phase shift of the laser beam to be diffracted. The amount of the phase shift is a value obtained by subtracting a phase difference that is an integral multiple of the wavelength of the laser beam to be diffracted from the phase difference.

Because the phase shift amount is subject to constraints of the wavelength of the laser beam which is different from the wavelength of the laser beam to be diffracted, it cannot be set to an arbitrary value. Specifically, the depth of the grooves of the grating element is constrained to substantially an integral multiple of the wavelength of the laser beam which is different from the wavelength of the laser beam to be diffracted. Therefore, the value of the phase shift amount is also constrained. In light of this, in the grating element according to Patent Literature 1, the ratio of the groove width and the inter-groove width (which is referred to hereinafter as a duty ratio) is deviated from 1:1. Normally, when the duty ratio is 1:1, light use efficiency is the highest. However, in the grating element according to Patent Literature 1, the duty ratio is deviated from 1:1 to thereby adjust the light intensity ratio of the main spot and the sub-spot to an appropriate value.

Further, Patent Literature 2 discloses a grating element in which a transparent substrate has a protrusion with a multilayer structure on its surface. Further, in the grating element, a recess on the surface of the transparent substrate is filled with a filler. This enables the implementation of the grating element that allows a diffraction efficiency to be constant when diffracting two laser beams with different wavelengths.

### Citation List

### Patent Literature

PTL 1: Japanese Unexamined Patent Publication No. 2001-281432

PTL 2: Japanese Unexamined Patent Publication No. 2008-107838

### SUMMARY OF INVENTION

### Technical Problem

However, the grating element disclosed in Patent Literature 1 and Patent Literature 2 both diffract two laser beams with different wavelengths. Thus, Patent Literature 1 and Patent Literature 2 do not give consideration to the technique of diffracting three laser beams with different wavelengths in a suitable manner. Therefore, they cannot be applied to an optical pickup optical system that incorporates a laser light source in which three semiconductor lasers with different wavelengths to be used for playing and recording of BDs, DVDs and CDs are integrated into one package. Specifically, even if the grating element according to Patent Literature 1 and Patent Literature 2 is placed in the common optical path from a laser light source to an optical disc, three laser beams with different wavelengths emitted from the laser light source cannot be diffracted in a suitable manner.

The present invention has been accomplished to solve the above problems and an object of the present invention is thus to provide a grating element, an optical pickup optical system and a method of designing a grating element which can split three or more laser beams with different wavelengths to be a main spot and a sub-spot in a suitable manner.

### Solution to Problem

The grating element according to the present invention includes a plurality of diffraction members each being configured such that a protrusion and a recess are arranged periodically on one surface of a transparent substrate. Further, the plurality of diffraction members are laminated in a substantially perpendicular direction to the transparent substrate. Furthermore, the protrusion of at least one diffraction member of the plurality of diffraction members is made of a dielectric multilayer film. In addition, the dielectric multilayer film has dielectric films of two or more types which are laminated on the transparent substrate in the substantially perpendicular direction. Then, wavelengths of laser beams that are diffracted at predetermined diffraction efficiencies by the plurality of diffraction members are different from one another.

In the present invention, the protrusion of at least one diffraction member is made of a dielectric multilayer film. The wavelengths of laser beams diffracted at predetermined diffraction efficiencies by the plurality of diffraction members constituting the grating element can be thereby different from one another. The grating element can thereby diffract three or more laser beams with different wavelengths in a suitable manner. The grating element can thereby split three or more laser beams with different wavelengths to be a main spot and a sub-spot in a suitable manner.

The grating element according to the present invention is preferably configured by three diffraction members laminated in the substantially perpendicular direction.

The grating element can thereby diffract three laser beams with different wavelengths in a suitable manner.

Further, the grating element according to the present invention is preferably configured by two diffraction members laminated in the substantially perpendicular direction.

The grating element can thereby diffract two laser beams with different wavelengths in a suitable manner.

Further, in the diffraction member with the protrusion made of the dielectric multilayer film, when a phase shift amount added to a laser beam to be diffracted at the predetermined diffraction efficiency is φ_{D} and a phase shift amount added to a laser beam to be not substantially diffracted is φ_{ND}, following expressions (3) and (4) are preferably satisfied:

0.10<|φ_{D}|≦0.25 (3),

0.00≦|φ_{ND}|≦0.10 (4)

By satisfying the expressions (3) and (4), the spectral ratio (the intensity of the 1st order diffracted beam/the intensity of the 0th order diffracted beam) of the laser beam to be diffracted at the predetermined diffraction efficiency can be about 0.05 to 0.1. If the value of the spectral ratio is smaller than 0.05, the intensity of a sub-spot decreases, which makes it difficult to obtain a suitable tracking signal. On the other hand, if the spectral ratio is larger than 0.1, the intensity of a main spot decreases, which causes a degradation of a reproduced signal level.

Specifically, as a phase shift amount added to a laser beam by a grating element increases, the intensity of the 0th order diffracted beam decreases, and the spectral ratio changes largely according to a change in the duty (the ratio of the width of a protrusion to the pitch of a grating structure of a diffraction member). Therefore, to obtain a desired spectral ratio, the intensity of the 0th order diffracted beam decreases, which leads to a degradation of a reproduced signal level. On the other hand, when the phase shift amount φ decreases, while the intensity of the 0th order diffracted beam increases, the spectral ratio is difficult to change even with a change in the duty, and it is difficult to obtain a desired spectral ratio at any duty.

Therefore, by satisfying the expressions (3) and (4), it is possible to obtain a suitable tracking signal and prevent the degradation of a reproduced signal level.

Further, it is preferred that the dielectric multilayer film is formed by lamination of the dielectric film made of a high refractive index material and the dielectric film made of a low refractive index material. Furthermore, in the diffraction member having the protrusion made of the dielectric multilayer film, when a wavelength of a laser beam diffracted at the predetermined diffraction efficiency is λ_{D}, a wavelength of a laser beam not substantially diffracted is λ_{ND}, a refractive index of the high refractive index material at the wavelength λ_{ND} is n_{HND}, a refractive index of the low refractive index material at the wavelength λ_{ND} is n_{LND}, a refractive index of a medium in a space adjacent to the dielectric multilayer film is n_{0ND}, a total thickness of the dielectric film made of the high refractive index material is d_{H}, and a total thickness of the dielectric film made of the low refractive index material is d_{L}, it is preferred to satisfy following expressions (5) and (6):

$$\begin{matrix}\frac{0.5 {λ}_{ND}}{( {n}_{HND} - {n}_{0 ND} )} \leq {d}_{H} < \frac{{λ}_{ND}}{( {n}_{HND} - {n}_{0 ND} )} , & ( 5 ) \\ {d}_{L} \leq \frac{{λ}_{ND} - ( {n}_{HND} - {n}_{0 ND} ) \times {d}_{H}}{( {n}_{LND} - {n}_{0 ND} )} & ( 6 )\end{matrix}$$

According to approximate calculation by the scalar diffraction theory, if there is a difference between a phase added when the laser beam with the wavelength λ_{ND} passes through the protrusion and a phase added when it passes through the recess, the intensity of the 0th order diffracted beam is 100% regardless of the height of the protrusion. However, according to strict calculation by the vector diffraction theory using electromagnetic field analysis, a diffraction efficiency varies depending on the height of the protrusion even if the phase difference is 2π. Therefore, the light use efficiency of the 0th order diffracted beam does not reach 100%. The decrease in the light use efficiency is particularly significant in the grating element having a diffraction structure with a narrow pitch.

However, by determining the total thickness d_{H} of the dielectric film made of the high refractive index material and the total thickness d_{L}, of the dielectric film made of the low refractive index material so as to satisfy the expressions (5) and (6), the light use efficiency of the 0th order diffracted beam calculated by the strict calculation can be improved. Specifically, by determining the height of the protrusion so as to satisfy the expressions (5) and (6), the light use efficiency of the 0th order diffracted beam calculated by the strict calculation can be improved.

Further, it is preferred that the dielectric multilayer film is formed by alternate lamination of the dielectric film made of a high refractive index material and the dielectric film made of a low refractive index material.

In such a structure, it is possible to suppress the reflection of a laser beam incident on the dielectric multilayer film. This reduces the return light to a light source. It is thereby possible to avoid the interference of the return light in a laser resonator to cause fluctuations of the laser output. It is thus possible to suppress laser noise.

Further, because the reflection of a laser beam can be suppressed, it is possible to allow a laser beam to pass at a high efficiency. In other words, it is possible to improve the light use efficiency.

It is also preferred that a reflectivity which is a rate that a laser beam incident on the dielectric multilayer film is reflected by the dielectric multilayer film is equal to or lower than 4%.

It is thereby possible to sufficiently suppress the laser noise. It is further possible to improve the light use efficiency.

Further, in the diffraction member with the protrusion made of the dielectric multilayer film, when a pitch of a grating structure of the diffraction member is P and a width of the protrusion is W, it is preferred to satisfy a following expression (7):

0.5<W/P<1.0 (7)

The width of the protrusion having an antireflection function can be thereby larger than the width of the recess having no antireflection function. Accordingly, the proportion of the protrusion on the surface of the grating element can be large. It is thereby possible to effectively suppress the reflection of a laser beam incident on the grating element.

Further, the plurality of diffraction members are preferably bonded together by an adhesive material.

It is thereby possible to prevent the displacement of the diffraction members in the grating element. Further, by using an adhesive material having a desired refractive index as the adhesive material, it is possible to set the diffraction efficiency and the 0th order diffracted beam use efficiency of the grating element to suitable values.

An optical pickup optical system according to the present invention includes a laser unit including a plurality of laser light sources that emit a plurality of laser beams with different wavelengths as a light source. Further, the above-described grating element is placed on an optical path of the laser beams emitted from the laser unit. It is thereby possible to diffract three or more laser beams with different wavelengths in a suitable manner. It is therefore possible to split three or more laser beams with different wavelengths to be a main spot and a sub-spot in a suitable manner.

A method of designing a grating element according to the present invention is a method of designing a grating element that includes a plurality of diffraction members each having a protrusion and a recess arranged periodically on one surface of a transparent substrate. The method laminates the plurality of diffraction members in a substantially perpendicular direction to the transparent substrate. Further, the method forms the protrusion of at least one diffraction member of the plurality of diffraction members by a dielectric multilayer film. Furthermore, the method forms the dielectric multilayer film by laminating dielectric films of two or more types in the substantially perpendicular direction on the transparent substrate. Then, wavelengths of laser beams diffracted at predetermined diffraction efficiencies by the plurality of diffraction members are different from one another.

In the present invention, the protrusion of at least one diffraction member is made of a dielectric multilayer film, so that the wavelengths of laser beams diffracted at predetermined diffraction efficiencies by the plurality of diffraction members constituting the grating element can be different from one another. The grating element can thereby diffract three or more laser beams with different wavelengths in a suitable manner. It is thereby possible to split three or more laser beams with different wavelengths to be a main spot and a sub-spot in a suitable manner.

It is preferred to laminate three diffraction members in the substantially perpendicular direction.

The grating element can thereby diffract three laser beams with different wavelengths in a suitable manner.

Further, it is preferred to laminate two diffraction members in the substantially perpendicular direction.

The grating element can thereby diffract two laser beams with different wavelengths in a suitable manner.

Further, in the diffraction member with the protrusion made of the dielectric multilayer film, when a phase shift amount added to a laser beam to be diffracted at the predetermined diffraction efficiency is φ_{D} and a phase shift amount added to a laser beam to be not substantially diffracted is φ_{ND}, it is preferred to satisfy following expressions (3) and (4):

0.10<|_{D}|≦0.25 (3),

0.00≦|_{ND}|≦0.10 (4).

By satisfying the expressions (3) and (4), the spectral ratio (the intensity of a diffracted beam at a certain order/the intensity of the 0th order diffracted beam) of the laser beam to be diffracted at the predetermined diffraction efficiency can be about 0.05 to 0.1. If the value of the spectral ratio is smaller than 0.05, the intensity of a sub-spot decreases, which makes it difficult to obtain a suitable tracking signal. On the other hand, if the spectral ratio is larger than 0.1, the intensity of a main spot decreases, which causes a degradation of a reproduced signal level.

Specifically, as a phase shift amount added to a laser beam by a grating element increases, the intensity of the 0th order diffracted beam decreases, and the spectral ratio changes largely according to a change in the duty (the ratio of the width of a protrusion to the pitch of a grating structure of a diffraction member). Therefore, to obtain a desired spectral ratio, the intensity of the 0th order diffracted beam decreases, which leads to a degradation of a reproduced signal level. On the other hand, when the phase shift amount φ decreases, while the intensity of the 0th order diffracted beam increases, the spectral ratio is difficult to change even with a change in the duty, and it is difficult to obtain a desired spectral ratio at any duty.

Therefore, by satisfying the expressions (3) and (4), it is possible to obtain a suitable tracking signal and prevent the degradation of a reproduced signal level.

Further, it is preferred to form the dielectric multilayer film by laminating the dielectric film made of a high refractive index material and the dielectric film made of a low refractive index material. Furthermore, in the diffraction members having the protrusion made of the dielectric multilayer film, when a wavelength of a laser beam diffracted at the predetermined diffraction efficiency is λ_{D}, a wavelength of a laser beam not substantially diffracted is λ_{ND}, a refractive index of the high refractive index material at the wavelength λ_{ND} is n_{HND}, a refractive index of the low refractive index material at the wavelength λ_{ND} is n_{LND}, a refractive index of a medium in a space adjacent to the dielectric multilayer film is B_{0ND}, a total thickness of the dielectric film made of the high refractive index material is d_{H}, and a total thickness of the dielectric film made of the low refractive index material is d_{L}, it is preferred to satisfy following expressions (5) and (6):

$$\begin{matrix}\frac{0.5 {λ}_{ND}}{( {n}_{HND} - {n}_{0 ND} )} \leq {d}_{H} < \frac{{λ}_{ND}}{( {n}_{HND} - {n}_{0 ND} )} , & ( 5 ) \\ {d}_{L} \leq \frac{{λ}_{ND} - ( {n}_{HND} - {n}_{0 ND} ) \times {d}_{H}}{( {n}_{LND} - {n}_{0 ND} )} & ( 6 )\end{matrix}$$

According to approximate calculation by the scalar diffraction theory, if there is a difference between a phase added when the laser beam with the wavelength λ_{ND} passes through the protrusion and a phase added when it passes through the recess, the intensity of the 0th order diffracted beam is 100% regardless of the height of the protrusion. However, according to strict calculation by the vector diffraction theory using electromagnetic field analysis, a diffraction efficiency varies depending on the height of the protrusion even if the phase difference is 2π. Therefore, the light use efficiency of the 0th order diffracted beam does not reach 100%. The decrease in the light use efficiency is particularly significant in the grating element having a diffraction structure with a narrow pitch.

However, by determining the total thickness d_{H} of the dielectric film made of the high refractive index material and the total thickness d_{L} of the dielectric film made of the low refractive index material so as to satisfy the expressions (5) and (6), the light use efficiency of the 0th order diffracted beam calculated by the strict calculation can be improved. Specifically, by determining the height of the protrusion so as to satisfy the expressions (5) and (6), the light use efficiency of the 0th order diffracted beam calculated by the strict calculation can be improved.

Further, it is preferred to form the dielectric multilayer film by alternately laminating the dielectric film made of a high refractive index material and the dielectric film made of a low refractive index material.

By forming the dielectric multilayer film in this manner, it is possible to suppress the reflection of a laser beam incident on the dielectric multilayer film. This reduces the return light to a light source. It is thereby possible to avoid the interference of the return light in a laser resonator to cause fluctuations of the laser output. It is thus possible to suppress laser noise.

Further, because the reflection of a laser beam can be suppressed, it is possible to allow a laser beam to pass at a high efficiency. In other words, it is possible to improve the light use efficiency.

It is also preferred that a reflectivity which is a rate that a laser beam incident on the dielectric multilayer film is reflected by the dielectric multilayer film is equal to or lower than 4%.

It is thereby possible to sufficiently suppress the laser noise. It is further possible to improve the light use efficiency.

Further, in the diffraction member with the protrusion made of the dielectric multilayer film, when a pitch of a grating structure of the diffraction member is P and a width of the protrusion is W, it is preferred to satisfy a following expression (7):

0.5<W/P<1.0 (7)

The width of the protrusion having an antireflection function can be thereby larger than the width of the recess having no antireflection function. Accordingly, the proportion of the protrusion on the surface of the grating element can be large. It is thereby possible to effectively suppress the reflection of a laser beam incident on the grating element.

Further, it is preferred to bond the plurality of diffraction members together by an adhesive material.

It is thereby possible to prevent the displacement of the diffraction members in the grating element. Further, by using an adhesive material having a desired refractive index as the adhesive material, it is possible to set the diffraction efficiency and the 0th order diffracted beam use efficiency of the grating element to suitable values.

### ADVANTAGEOUS EFFECTS OF INVENTION

According to the present invention, it is possible to split three or more laser beams with different wavelengths to be a main spot and a sub-spot in a suitable manner.

### BRIEF DESCRIPTION OF DRAWINGS

FIG. 1 is a view showing an example of an optical pickup optical system according to an embodiment of the present invention;

FIG. 2 is a side view showing an example of a grating element according to an embodiment of the present invention;

FIG. 3 is a view to explain diffraction in a grating element according to an embodiment of the present invention;

FIG. 4 is a graph showing a relationship between a phase shift amount added to a laser beam by a grating element made of a single material and the depth of a grating (the height of a protrusion);

FIG. 5 is a graph showing a dependence of the intensity of the 0th order diffracted beam and a spectral ratio (the intensity of the 1st order diffracted beam/the intensity of the 0th order diffracted beam) on a duty (the ratio of the width of a protrusion to the pitch of a grating structure of a diffraction member) in a grating element;

FIG. 6 is a graph showing a dependence of the intensity of the 0th order diffracted beam and a spectral ratio (the intensity of the 1st order diffracted beam/the intensity of the 0th order diffracted beam) on a duty (the ratio of the width of a protrusion to the pitch of a grating structure of a diffraction member) in a grating element;

FIG. 7 is a graph showing a dependence of the intensity of the 0th order diffracted beam and a spectral ratio (the intensity of the 1st order diffracted beam/the intensity of the 0th order diffracted beam) on a duty (the ratio of the width of a protrusion to the pitch of a grating structure of a diffraction member) in a grating element;

FIG. 8 is a graph showing a dependence of the intensity of the 0th order diffracted beam and a spectral ratio (the intensity of the 1st order diffracted beam/the intensity of the 0th order diffracted beam) on a duty (the ratio of the width of a protrusion to the pitch of a grating structure of a diffraction member) in a grating element;

FIG. 9 is a view to explain a relationship between the pitch of a diffraction structure and the width of a protrusion.

FIG. 10 is a side view showing an example of a grating element according to an embodiment of the present invention;

FIG. 11 is a side view showing an example of a grating element according to an embodiment of the present invention;

FIG. 12 is a graph showing a relationship between the light use efficiency of the 0th order diffracted beam of a laser beam with a wavelength of 0.785 μm and a grating depth;

FIG. 13 is a table showing a structure of a dielectric multilayer film that forms a protrusion of a diffraction member according to an example 1;

FIG. 14 is a graph showing the intensity of a diffracted beam when laser beams with wavelengths of 0.405 μm, 0.660 μm and 0.785 μm are diffracted by the diffraction member according to the example 1;

FIG. 15A is a graph showing a wavelength dependence of a reflectivity of a dielectric multilayer film that forms a protrusion of the diffraction member according to the example 1;

FIG. 15B is a graph showing a wavelength dependence of a reflectivity of a dielectric multilayer film that forms a protrusion of the diffraction member according to the example 1;

FIG. 15C is a graph showing a wavelength dependence of a reflectivity of a dielectric multilayer film that forms a protrusion of the diffraction member according to the example 1;

FIG. 16 is a table showing a structure of a dielectric multilayer film that forms a protrusion of the diffraction member according to the example 1;

FIG. 17 is a graph showing the intensity of a diffracted beam when laser beams with wavelengths of 0.405 μm, 0.660 μm and 0.785 μm are diffracted by the diffraction member according to the example 1;

FIG. 18A is a graph showing a wavelength dependence of a reflectivity of a dielectric multilayer film that forms a protrusion of the diffraction member according to the example 1;

FIG. 18B is a graph showing a wavelength dependence of a reflectivity of a dielectric multilayer film that forms a protrusion of the diffraction member according to the example 1;

FIG. 18C is a graph showing a wavelength dependence of a reflectivity of a dielectric multilayer film that forms a protrusion of the diffraction member according to the example 1;

FIG. 19 is a graph showing the intensity of a diffracted beam when laser beams with wavelengths of 0.405 μm, 0.660 μm and 0.785 μm are diffracted by the diffraction member according to the example 1;

FIG. 20 is a table showing a structure of a dielectric multilayer film that forms a protrusion of a diffraction member according to an example 2;

FIG. 21 is a graph showing the intensity of a diffracted beam when laser beams with wavelengths of 0.660 μm and 0.785 μm are diffracted by the diffraction member according to the example 2;

FIG. 22 is a graph showing the intensity of a diffracted beam when laser beams with wavelengths of 0.660 μm and 0.785 μm are diffracted by a hitherto used diffraction grating;

FIG. 23 is a graph showing a wavelength dependence of a reflectivity of a dielectric multilayer film that forms a protrusion of the diffraction member according to the example 2; and

FIG. 24 is a graph showing the intensity of a diffracted beam when laser beams with wavelengths of 0.660 μm and 0.785 μm are diffracted by the diffraction member according to the example 2.

### DESCRIPTION OF EMBODIMENTS

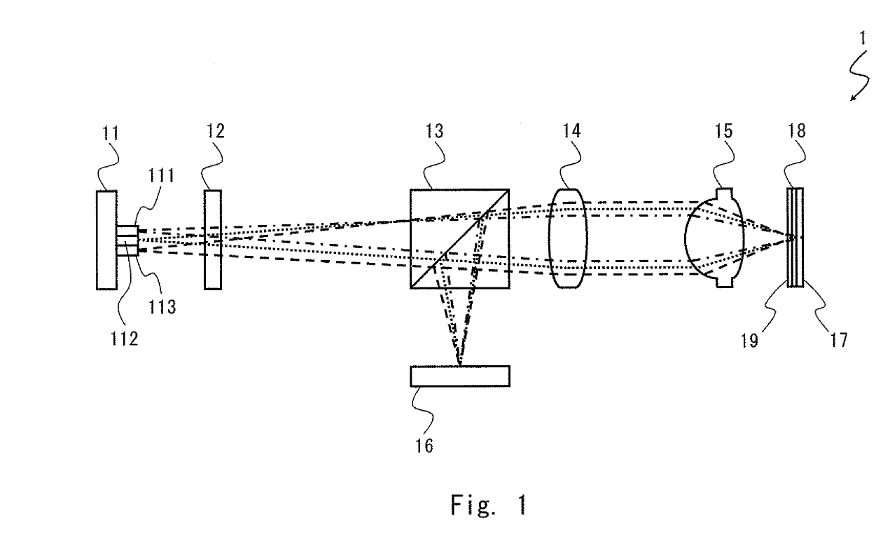

A specific example of the present invention is described hereinafter in detail with reference to the drawings. Note that the present invention is not limited to the following embodiment. FIG. 1 shows an example of an optical pickup optical system 1 according to an embodiment of the present invention. The optical pickup optical system 1 includes a laser unit 11 (light source), a grating element 12, a beam splitter 13, a collimator lens 14, a pickup lens 15, and a detection system 16. In this embodiment, a CD 17, a DVD 18 and a BD 19 are taken as examples of optical discs. Note that the optical discs to which the present invention is applicable are not limited to the CD 17, the DVD 18 and the BD 19.

The laser unit 11 includes a CD laser light source 111, a DVD laser light source 112, and a BD laser light source 113. A wavelength of a laser beam emitted from the CD laser light source 111, a wavelength of a laser beam emitted from the DVD laser light source 112, and a wavelength of a laser beam emitted from the BD laser light source 113 are different from one another. In this embodiment, the CD laser light source 111 emits a laser beam with a wavelength 0.785 μm which is a laser beam used for recording and reproducing the CD 17. The DVD laser light source 112 emits a laser beam with a wavelength 0.660 μm which is a laser beam used for recording and reproducing the DVD 18. The BD laser light source 113 emits a laser beam with a wavelength 0.405 μm which is a laser beam used for recording and reproducing the BD 19. In the laser unit 11, the CD laser light source 111, the DVD laser light source 112 and the BD laser light source 113 are integrated into one package. In FIG. 1, an optical path of a laser beam emitted from the CD laser light source 111 is indicated by a broken line. Further, an optical path of a laser beam emitted from the DVD laser light source 112 is indicated by a dotted line. Furthermore, an optical path of a laser beam emitted from the BD laser light source 113 is indicated by an alternate long and short dash line. Note that two semiconductor laser light sources may be included in the laser unit 11. Further, three or more semiconductor laser light sources with different wavelengths may be included in the laser unit 11.

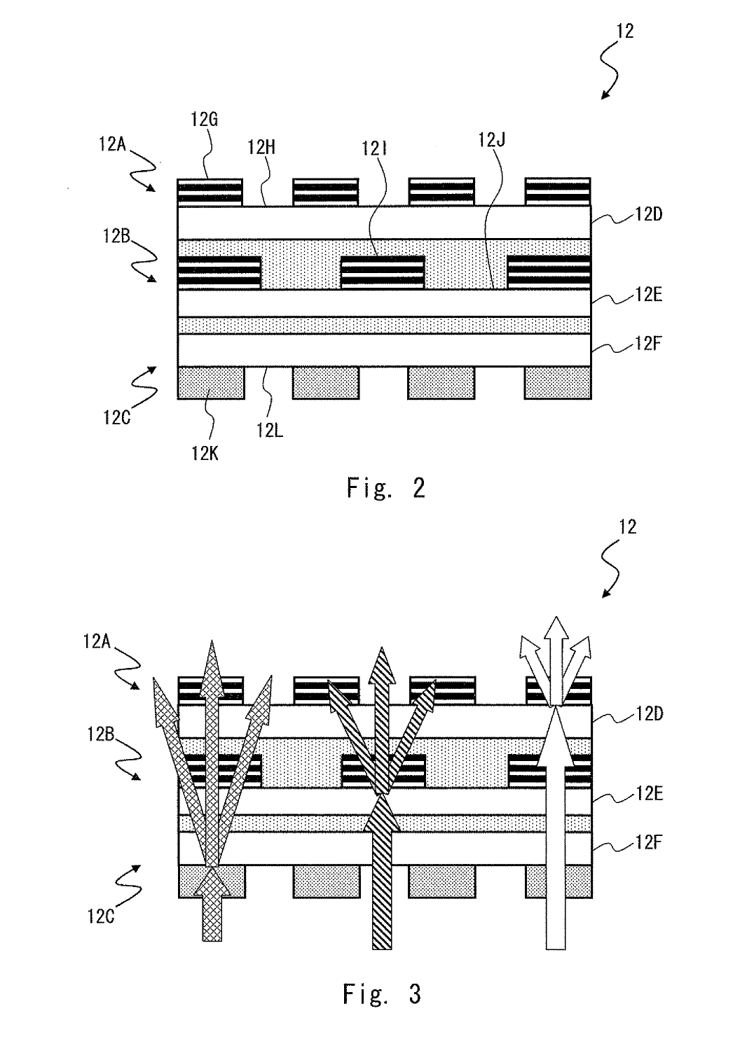

The grating element 12 is placed on the optical paths of the laser beams emitted from the laser unit 11. FIG. 2 shows a side view showing an example of the grating element 12 according to the embodiment of the present invention. FIG. 3 shows the way of diffraction in the grating element 12.

As shown in FIG. 2, the grating element 12 includes a plurality of diffraction members 12A, 12B and 12C. In the diffraction member 12A, a protrusion 12G and a recess 12H are alternately arranged on one surface of a transparent substrate 12D. Likewise, in the diffraction member 12B, a protrusion 12I and a recess 12J are alternately arranged on one surface of a transparent substrate 12E. Further, in the diffraction member 12C, a protrusion 12K and a recess 12L are alternately arranged on one surface of a transparent substrate 12F. Further, the plurality of diffraction members 12A, 12B and 12C are laminated in the substantially perpendicular direction to the transparent substrates 12D, 12E and 12F.

As shown in FIG. 3, the wavelengths of laser beams which are diffracted by the plurality of diffraction members 12A, 12B and 12C are different from one another. Further, each of the plurality of diffraction members 12A, 12B and 12C diffracts a laser beam and mainly generates the 0th order diffracted beam, the +1st order diffracted beam and the 1st order diffracted beam.

The beam splitter 13 is placed on the optical paths of the laser beams output from the grating element 12. Further, the collimator lens 14 is placed on the optical paths of the laser beams output from the beam splitter 13. The collimator lens 14 converts the laser beams emitted from the laser unit 11 from divergent light to substantially parallel light.

The pickup lens 15 is placed on the optical paths of the laser beams having passed through the collimator lens 14.

The pickup lens 15 has a function of focusing the incident light beams on information recording surfaces of the optical discs 17, 18 and 19 close to a diffraction limit. Specifically, the pickup lens 15 focuses the 0th order diffracted beam, the +1st order diffracted beam and the −1st order diffracted beam generated in the grating element 12 on the optical discs 17, 18 and 19. Then, the 0th order diffracted beam forms an optical spot for signal reproduction (which is referred to hereinafter as a main spot) on the optical discs 17, 18 and 19. Further, the ±1 st order diffracted beams form an optical spot for tracking signal generation (which is referred to hereinafter as a sub-spot) on the optical discs 17, 18 and 19. The pickup lens 15 further has a function of guiding the laser beams reflected by the information recording surfaces of the optical discs 17, 18 and 19 to the detection system 16.

Further, at the time of focus servo and tracking servo, the pickup lens 15 is driven by an actuator, which is not shown.

Hereinafter, the behavior of a laser beam which is emitted from the laser unit 11, reflected by the information recording surface of the optical disc 17, 18 or 19 and detected by the detection system 16 is described. The laser beam emitted from the laser unit 11 is diffracted by the grating element 12 and output mainly as the 0th order diffracted beam, the +1st order diffracted beam and the −1st order diffracted beam. The 0th order diffracted beam, the +1st order diffracted beam and the −1st order diffracted beam output from the grating element 12 pass through the beam splitter 13 and enter the collimator lens 14.

The collimator lens 14 converts the 0th order diffracted beam, the +1st order diffracted beam and the −1st order diffracted beam emitted from the laser unit 11 from divergent light to substantially parallel light.

The 0th order diffracted beam, the +1st order diffracted beam and the −1st order diffracted beam having passed through the collimator lens 14 is made incident on the pickup lens 15. The pickup lens 15 focuses the 0th order diffracted beam, the +1st order diffracted beam and the −1st order diffracted beam on the information recording surface of the optical disc 17, 18 or 19 close to a diffraction limit. The 0th order diffracted beam, the +1st order diffracted beam and the −1st order diffracted beam reflected by the information recording surface of the optical disc 17, 18 or 19 enter the detection system 16 through the pickup lens 15 and are detected. The detection system 16 detects the 0th order diffracted beam, the +1st order diffracted beam and the −1st order diffracted beam and performs photoelectric conversion, thereby generating a reproduced signal, a focus servo signal, a tracking servo signal or the like.

The grating element 12 which is used in the optical pickup optical system 1 according to the embodiment of the present invention is described hereinafter in detail.

As shown in FIG. 2 and FIG. 3, the grating element 12 includes the plurality of diffraction members 12A, 12B and 12C. In the diffraction member 12A, the protrusion 12G and the recess 12H are alternately arranged on an output surface of the transparent substrate 12D. Stated differently, the protrusion 12G and the recess 12H are periodically formed on the output surface of the transparent substrate 12D of the diffraction member 12A. Likewise, the protrusion 12I and the recess 12J are periodically formed on an output surface of the transparent substrate 12E of the diffraction member 12B. Further, the protrusion 12K and the recess 12L are periodically formed on an input surface of the transparent substrate 12F of the diffraction member 12C. The plurality of diffraction members 12A, 12B and 12C are bonded by together an adhesive material so that they are laminated in the substantially perpendicular direction to the transparent substrates 12D, 12E and 12F.

As the transparent substrates 12D, 12E and 12F, a substrate made of glass, quartz, resin or the like may be used,

Further, the protrusion 12G formed on the output surface of the transparent substrate 12D and the protrusion 12I formed on the output surface of the transparent substrate 12E are made of a dielectric multilayer film. The dielectric multilayer film has dielectric films of two or more types which are laminated in the substantially perpendicular direction to the transparent substrates 12D and 12E. In the grating element shown in FIG. 2 and FIG. 3, the dielectric multilayer film is formed by alternately laminating a dielectric film with a refractive index of about 1.8 to 2.3 (high refractive index material) and a dielectric film with a refractive index of about 1.3 to 1.6 (low refractive index material). As the high refractive index material, TiO₂, Ta₂O₅, ZrO₂, Nb₂O₅ or the like may be used. As the low refractive index material, SiO₂, MgF₂, CaF₂ or the like may be used. Further, the dielectric films can be deposited using vacuum deposition, sputtering or the like. Particularly, ion-assisted deposition and ion-beam sputtering which are often used in an optical multilayer film can suitably control the film flatness and the film thickness. It is therefore more preferred to deposit the dielectric films by using the ion-assisted deposition or the ion-beam sputtering.

Further, after forming the dielectric multilayer film on the transparent substrates 12D and 12E, the recess 12H of the transparent substrate 12D and the recess 12J of the transparent substrate 12E are made by using photolithography, dry etching, ion milling or the like. Alternatively, after forming a resist on the transparent substrates 12D and 12E by using photolithography, the dielectric multilayer film may be deposited. After that, the resist is removed, so that the recess 12H of the transparent substrate 12D and the recess 12J of the transparent substrate 12E are made.

Further, the protrusion 12K is made on the output surface of the transparent substrate 12F by using UV curable resin. Alternatively, the protrusion 12K and the recess 12L may be made on the output surface of the transparent substrate 12F by using dry etching or the like. Further, the transparent substrate 12F may be formed by injection molding so that the output surface of the transparent substrate 12F has a protrusion-and-recess pattern with the protrusion 12K and the recess 12L.

The function of the grating element 12 shown in FIG. 2 is described hereinafter with reference to FIG. 3. In FIG. 3, the arrow indicated by cross-hatching, the arrow indicated by hatching and the open arrow respectively indicate laser beams of different wavelengths. The laser beam indicated by the arrow in cross-hatching is diffracted by the diffraction member 12C at a predetermined diffraction efficiency and not substantially diffracted by the diffraction members 12A and 12B. Further, the laser beam indicated by the arrow in hatching is diffracted by the diffraction member 12B at a predetermined diffraction efficiency and not substantially diffracted by the diffraction members 12A and 12C. Furthermore, the laser beam indicated by the open arrow is diffracted by the diffraction member 12A at a predetermined diffraction efficiency and not substantially diffracted by the diffraction members 12B and 12C. Thus, the wavelengths of the laser beams that are diffracted at predetermined diffraction efficiencies by the plurality of diffraction members 12A, 12B and 12C are different from one another.

The predetermined diffraction efficiency is diffraction efficiency for generating a predetermined amount of diffracted beam. Further, the predetermined amount is the intensity of a diffracted beam with which a spectral ratio is in the range of about 0.05 to 0.10 when the spectral ratio is (the intensity of a diffracted beam at a certain order/the intensity of the 0th order diffracted beam). Therefore, the wavelengths of the laser beams that are diffracted by the plurality of diffraction members 12A, 12B and 12C so that the spectral ratio is about 0.05 to 0.10 are different from one another.

If the spectral ratio is smaller than 0.05, the intensity of the sub-spot decreases, which makes it difficult to obtain a suitable tracking signal. On the other hand, if the spectral ratio is larger than 0.10, the intensity of the main spot decreases, which causes a degradation of a reproduced signal level. It is therefore preferred to diffract laser beams so that the spectral ratio is about 0.05 to 0.10.

In the grating element according to the embodiment of the present invention, because the plurality of diffraction members 12A, 12B and 12C diffract laser beams so that the spectral ratio is about 0.05 to 0.10, it is possible to prevent the degradation of a reproduced signal level and obtain a suitable tracking signal.

Further, in the grating element 12, the wavelengths of the laser beams that are diffracted by the plurality of diffraction members 12A, 12B and 12C are different from one another. Therefore, the grating element 12 can diffract the laser beams emitted from the CD laser light source 111, the DVD laser light source 112 and the BD laser light source 113 of the laser unit 11 independently of one another and form a main spot and a sub-spot on the CD 17, the DVD 18 and the BD 19, respectively. Thus, the grating element 12 can be incorporated into an optical disc drive device that plays the CD 17, the DVD 18 and the BD 19 and uses a laser unit in which a plurality of blue/red/infrared semiconductor lasers are integrated into one package as a light source, for example. In this case, the grating element 12 can form the main spot and the sub-spot on the CD 17, the DVD 18 and the BD 19 from the laser beams emitted from the plurality of blue/red/infrared semiconductor lasers independently of one another.

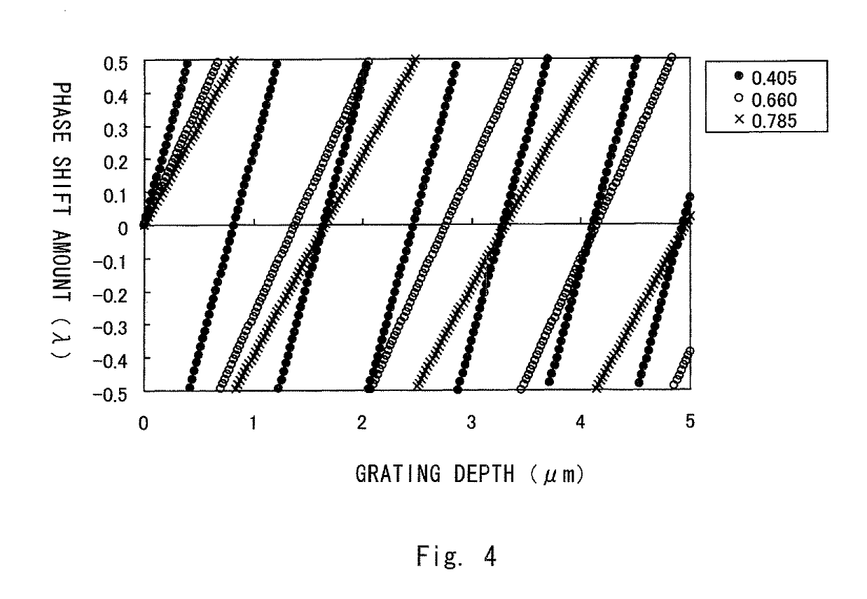

FIG. 4 shows a relationship between a phase shift amount added to a laser beam by a grating element made of a single material and the depth of a grating (the height of a protrusion). The grating element is a transparent substrate having a protrusion-and-recess pattern on one surface. In the graph of FIG. 4, the horizontal axis indicates the grating depth (μm) and the vertical axis indicates the phase shift amount (λ). Further, the black circle mark indicates a laser beam with a wavelength of 0.405 μm, the white circle mark indicates a laser beam with a wavelength of 0.660 μm, and the cross mark indicates a laser beam with a wavelength of 0.785 μm. Furthermore, the refractive index of the single material is 1.492 at the wavelength of 0.405 μm, 1.477 at the wavelength of 0.660 μm, and 1.475 at the wavelength of 0.785 μm. The laser beam with the wavelength of 0.405 μm is usually used for recording and playing of the BD 19. Further, the laser beam with the wavelength of 0.660 μm is usually used for recording and playing of the DVD 18. Furthermore, the laser beam with the wavelength of 0.785 μm is usually used for recording and playing of the CD 17.

The grating element is a transparent substrate having a protrusion-and-recess pattern on one surface, which is made of a single material. Therefore, in order to selectively diffract a plurality of laser beams with different wavelengths, it is necessary to set the grating depth in order that a phase shift amount added to a laser beam diffracted by the grating element becomes an appropriate value and a phase shift amount added to a laser beam not diffracted by the grating element becomes about 0λ. As shown in FIG. 4, at the grating depth of about 1.65 μm, a phase shift amount added to the laser beam with the wavelength of 0.660 μm is about 0.19λ, and a phase shift amount added to the laser beams with the wavelengths of 0.405 μm and 0.785 μm is about 0λ. Thus, only the laser beam with the wavelength of 0.660 μm can be selectively diffracted by the grating element with the grating depth of about 1.65 μm. Further, at the grating depth of about 4.63 μm, although a phase shift amount added to the laser beams with the wavelengths of 0.405 μm and 0.660 μm is about 0λ, a phase shift amount added to the laser beam with the wavelength of 0.785 μm is about 0.5λ, which is too large. Thus, the laser beam with the wavelength of 0.785 μm cannot be diffracted at a suitable diffraction efficiency. Further, it is obvious from FIG. 4 that the grating depth at which an appropriate phase shift amount is added to the laser beam with the wavelength of 0.405 μm and a phase shift amount added to the laser beams with the wavelengths of 0.660 μm and 0.785 μm is about 0λ does not exist in the practical range (0 to 5 μm) of the grating depth. Therefore, the grating element made of a single material cannot selectively diffract the three laser beams with different wavelengths. In light of this, in the grating element 12 according to an example of the embodiment, the protrusions 12G and 12I of at least one diffraction members 12A and 12B of the plurality of diffraction members 12A, 12B and 12C are made of a dielectric multilayer film. For example, protrusions in diffraction members that diffract the laser beam with the wavelength of 0.405 μm and the laser beam with the wavelength of 0.785 μm at predetermined diffraction efficiencies are made of a dielectric multilayer film. Note that the protrusions 12G, 12I and 12K of all the diffraction members 12A, 12B and 12C may be made of a dielectric multilayer film as a matter of course.

A structure of a dielectric multilayer film according to the embodiment is described hereinafter in detail. When a wavelength of a laser beam passing through a dielectric multilayer film is λ, a refractive index of a medium in a space adjacent to the dielectric multilayer film is n₀, a refractive index of a high refractive index material forming the dielectric multilayer film is n_{H}, a refractive index of a low refractive index material forming the dielectric multilayer film is n_{L}, a total thickness of the high refractive index material is d_{H}, and a total thickness of the low refractive index material is d_{L}, a phase shift amount φ (in unit of wavelength λ) added to the laser beam having passed through the dielectric multilayer film is represented by the following expression (8).

φ={(n_{H}−n₀)×d_{H}+(n_{L}−n₀)×d_{L}}/λ−Round[{(n_{H}−n₀)×d_{H}+(n_{L}−n₀)×d_{L}}/λ] (8)

“Round” is a function that rounds off a factor to an integer. d_{H} and d_{L} are set in consideration of a change in n_{H} and n_{L} due to wavelength dispersion. d_{H} and d_{L} that can diffract only one laser beam of a plurality of laser beams with different wavelengths at a predetermined diffraction efficiency can be thereby set. Stated differently, the height of the protrusions 12G and 12I (the height of the dielectric multilayer film) that can diffract only one laser beam of a plurality of laser beams with different wavelengths at a predetermined diffraction efficiency can be thereby set.

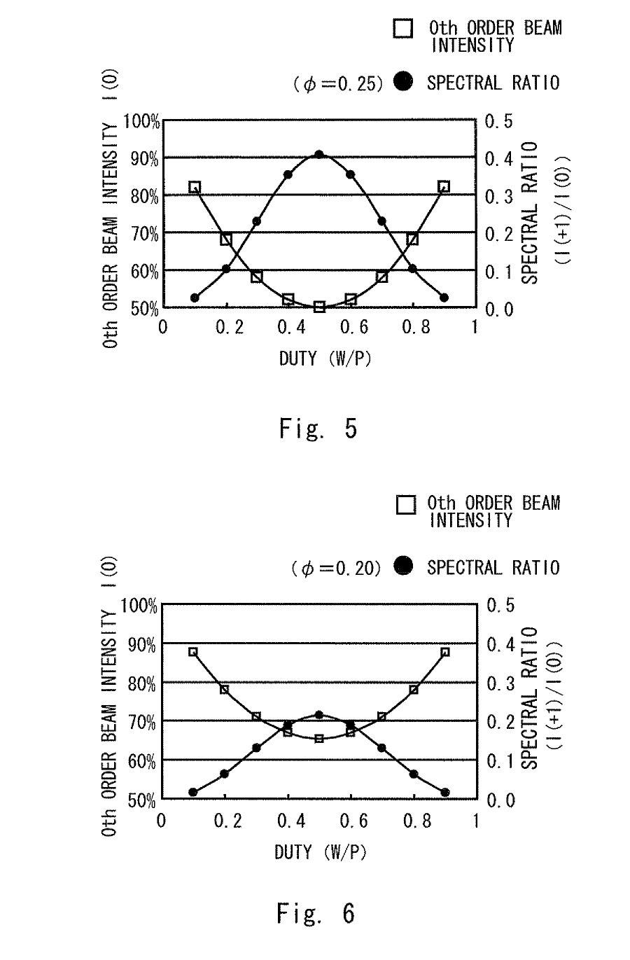

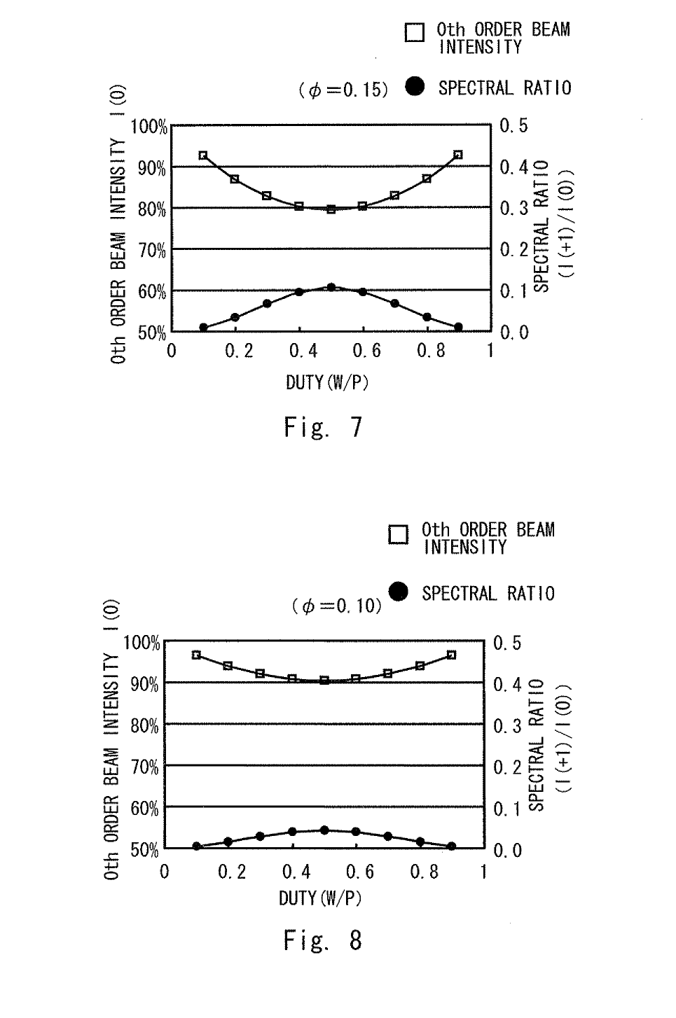

A suitable phase shift amount added to each laser beam by the grating element 12 is described hereinbelow. FIGS. 5, 6, 7 and 8 show a dependence of the intensity of the 0th order diffracted beam and the spectral ratio (the intensity of the 1st order diffracted beam/the intensity of the 0th order diffracted beam) on a duty (the ratio of the width of a protrusion to the pitch of a grating structure of a diffraction member) in a grating element. The grating element shown in FIGS. 5 to 8 is a transparent substrate having a protrusion-and-recess pattern on one surface, which is made of a single material. Further, FIGS. 5, 6, 7 and 8 show a dependence of the intensity of the 0th order diffracted beam and the spectral ratio (the intensity of the 1st order diffracted beam/the intensity of the 0th order diffracted beam) on a duty (the ratio of the width of a protrusion to the pitch of a grating structure of a diffraction member) when the phase shift amount φ=0.25, φ=0.20, φ=0.15 and φ=0.10, respectively. Further, in FIGS. 5 to 8, the vertical axis on the left side indicates the intensity I(0) of the 0th order diffracted beam, the vertical axis on the right side indicates the spectral ratio (I(+1)/I(0)), and the horizontal axis indicates the duty (W/P). Furthermore, in FIGS. 5 to 8, the open square mark indicates the intensity I(0) of the 0th order diffracted beam, and the black circle mark indicates the spectral ratio (I(+1)/I(0)). The duty is the ratio of the width W of a protrusion to the pitch P (the sum of the width of a protrusion and the width of a recess) of a grating structure of the diffraction member as shown in FIG. 9.

The intensity of a diffracted beam is calculated on the assumption that the phase is a periodic function. Specifically, each coefficient of Fourier series expansion of a phase function is calculated, and the square of the absolute value of each coefficient is calculated.

As shown in FIGS. 5 to 8, as φ increases, the intensity 1(0) of the 0th order diffracted beam decreases, and the spectral ratio (I(+1)/I(0)) changes greatly according to a change in the duty (W/P). Therefore, to obtain a desired spectral ratio (I(+1)/I(0)), the intensity I(0) of the 0th order diffracted beam decreases, which leads to a degradation of a reproduced signal level. On the other hand, when the phase shift amount φ decreases, while the intensity I(0) of the 0th order diffracted beam increases, the spectral ratio (I(+1)/I(0)) is difficult to change even with a change in the duty, and it is thus difficult to obtain a desired spectral ratio (I(+1)/I(0)) at any duty (W/P).

As described earlier, the spectral ratio (I(+1)/I(0)) is preferably in the range of 0.05 to 0.10. Thus, in the grating element 12 according to the embodiment, d_{H} and d_{L}, are set so as to satisfy the following expressions (3) and (4) when a phase shift amount added to a laser beam to be diffracted is φ_{D} and a phase shift amount added to a laser beam to be not substantially diffracted is φ_{ND}.

0.10<|φ_{D}|≦0.25 (3)

0.00≦|φ_{ND}|≦0.10 (4)

By satisfying the expression (3), the spectral ratio (I(+1)/I(0)) can be set in the range of 0.05 to 0.10 in the wavelength to be diffracted. It is thereby possible to prevent the degradation of a reproduced signal level and obtain a suitable tracking signal.

Further, by satisfying the expression (4), the intensity I(0) of the 0th order diffracted beam of the laser beam to be not substantially diffracted is larger than 90%. It is thereby possible to improve the light use efficiency of the 0th order diffracted beam of the laser beam to be not substantially diffracted.

Further, the dielectric multilayer film according to the embodiment is formed by alternate lamination of a dielectric film made of a high refractive index material and a dielectric film made of a low refractive index material. The dielectric multilayer film according to the embodiment thereby has a function of preventing a laser beam incident on the dielectric multilayer film from being reflected by the dielectric multilayer film.

Further, the number of layers of the dielectric multilayer film according to the embodiment is determined in such a way that a reflectivity of a laser beam incident on the dielectric multilayer film by the dielectric multilayer film is low. The reflectivity is the ratio of the intensity of a laser beam reflected by the dielectric multilayer film to the intensity of a laser beam incident on the dielectric multilayer film.

Furthermore, in the grating element 12, the recesses 12H, 12J and 12L are made of the same material as the transparent substrates 12D, 12E and 12F, respectively. Therefore, in the recesses 12H, 12J and 12L, a laser beam incident on the grating element 12 is reflected according to the refractive indexes of the transparent substrates 12D, 12E and 12F. Thus, when the pitch of the grating structure of the diffraction members 12A and 12B is P and the width of the protrusions 12G and 12I is W, it is preferred to satisfy the following expression (7).

0.5<W/P<1.0 (7)

The width of the protrusions 120 and 121 having an antireflection function can be thereby larger than the width of the recesses 12H and 12J not having an antireflection function. Accordingly, the proportion of the protrusions 12G and 12I on the surface of the grating element 12 can be large. It is thereby possible to effectively suppress the reflection of a laser beam incident on the grating element 12. Specifically, it is preferred to select a duty (W/P) at which the reflectivity of a laser beam incident on the dielectric multilayer film by the dielectric multilayer film is 4% or below.

Note that, as shown in FIGS. 5 to 8, the plot shape of the intensity I(0) of the 0th order diffracted beam and the plot shape of the spectral ratio (I(+1)/I(0)) is symmetrical in the range of 0≦W/P≦0.5 and the range of 0.5≦W/P≦1. Thus, the intensity I(0) of the 0th order diffracted beam and the spectral ratio (I(+1)/I(0)) obtained in the range of 0≦W/P≦0.5 and the intensity I(0) of the 0th order diffracted beam and the spectral ratio (I(+1)/I(0)) obtained in the range of 0.5≦W/P≦1 are substantially the same. Therefore, in this embodiment, the duty is set within the range of 0.5≦W/P≦1.0, in which the reflection of an incident beam can be more suppressed.

Hereinafter, a grating element 120 according to another example of the embodiment is described with reference to FIG. 10.

As shown in FIG. 10, the grating element 120 includes a plurality of diffraction members 120A and 120B. In the diffraction member 120A, a protrusion 120E and a recess 120F are alternately arranged on the output surface of a transparent substrate 120C. Stated differently, the protrusion 120E and the recess 120F are arranged periodically on the output surface of the transparent substrate 120C of the diffraction member 120A. Likewise, a protrusion 120G and a recess 120H are arranged periodically on the output surface of a transparent substrate 120D of the diffraction member 120B. Further, the plurality of diffraction members 120A and 120B are bonded by together an adhesive material so that they are laminated in the direction substantially perpendicular to the transparent substrates 120C and 120D. Specifically, the input surface of the transparent substrate 120C and the output surface of the transparent substrate 120D are bonded by together an adhesive material. A material of the transparent substrates 120C and 120D is the same as that of the transparent substrates 12D, 12E and 12F and thus an explanation thereof is omitted.

Further, the protrusion 120G formed on the output surface of the transparent substrate 120D is made of a dielectric multilayer film. A material and a manufacturing process of the dielectric multilayer film are the same as those of the grating element 12 and thus an explanation thereof is omitted. Furthermore, a method of making the recess 120H of the transparent substrate 120D is the same as that of the recess 12H and the recess 12J and thus an explanation thereof is omitted.

Further, a method of making the protrusion 120E and the recess 120F of the transparent substrate 120C is the same as that of the protrusion 12K and the recess 12L of the transparent substrate 12F and thus an explanation thereof is omitted.

The function of the grating element 120 is described hereinafter with reference to FIG. 10. In FIG. 10, the arrow indicated by hatching, the open arrow and the arrow indicated by cross-hatching respectively indicate laser beams of different wavelengths. The laser beam indicated by the arrow in hatching is diffracted by the diffraction member 120B at a predetermined diffraction efficiency and not substantially diffracted by the diffraction member 120A. Further, the laser beam indicated by the open arrow is diffracted by the diffraction member 120A at a predetermined diffraction efficiency and not substantially diffracted by the diffraction member 120B. Furthermore, the laser beam indicated by the arrow in cross-hatching is not substantially diffracted by the diffraction members 120A and 120B. Thus, the wavelengths of the laser beams that are diffracted at predetermined diffraction efficiencies by the plurality of diffraction members 120A and 120B are different from each other. Further, the laser beam indicated by the arrow in cross-hatching is not substantially diffracted and passes through the grating element 120.

Further, as described earlier, the spectral ratio (I(+1)/I(0)) is preferably in the range of 0.05 to 0.10. Thus, in the grating element 120 according to the embodiment, d_{H} and d_{L} are set so as to satisfy the following expressions (3) and (4) when a phase shift amount added to a laser beam to be diffracted is φ_{D} and a phase shift amount added to a laser beam to be not substantially diffracted is φ_{ND}.

0.10≦|φ_{D}|≦0.25 (3)

0.00≦|φ_{ND}|≦0.10 (4)

By satisfying the expression (3), the spectral ratio (I(+1)/I(0)) can be set in the range of 0.05 to 0.10 in the wavelength to be diffracted. It is thereby possible to prevent the degradation of a reproduced signal level and obtain a suitable tracking signal.

Further, by satisfying the expression (4), the intensity I(0) of the 0th order diffracted beam of the laser beam to be not substantially diffracted is larger than 90%. It is thereby possible to improve the light use efficiency of the 0th order diffracted beam of the laser beam to be not substantially diffracted.

Stated differently, the diffraction member 120A diffracts the laser beam indicated by the open arrow to the k-th order (k≠0) at a higher diffraction efficiency than the laser beam indicated by the arrow in hatching and the laser beam indicated by the arrow in cross-hatching. Further, the diffraction member 120A does not substantially diffract the laser beam indicated by the arrow in hatching and the laser beam indicated by the arrow in cross-hatching. Note that “not substantially diffracting the laser beam indicated by the arrow in hatching and the laser beam indicated by the arrow in cross-hatching” means slightly diffracting the laser beam indicated by the arrow in hatching and the laser beam indicated by the arrow in cross-hatching so that the intensity I(0) of the 0th order diffracted beam of the laser beam indicated by the arrow in hatching and the laser beam indicated by the arrow in cross-hatching is larger than 90% of the intensity of the incident beam.

Likewise, the diffraction member 120B diffracts the laser beam indicated by the arrow in hatching to the k-th order (kg)) at a higher diffraction efficiency than the laser beam indicated by the open arrow and the laser beam indicated by the arrow in cross-hatching. Further, the diffraction member 120B does not substantially diffract the laser beam indicated by the open arrow and the laser beam indicated by the arrow in cross-hatching. Note that “not substantially diffracting the laser beam indicated by the open arrow and the laser beam indicated by the arrow in cross-hatching” means slightly diffracting the laser beam indicated by the open arrow and the laser beam indicated by the arrow in cross-hatching so that the intensity I(0) of the 0th order diffracted beam of the laser beam indicated by the open arrow and the laser beam indicated by the arrow in cross-hatching is larger than 90% of the intensity of the incident beam.

The grating element 120 having such a function may be used in an optical disc drive device in which a tracking method differs depending on the wavelength of a laser beam (depending on the type of an optical disc), and a method of splitting a laser beam into three beams and a method of not splitting a laser beam are both performed, for example. For example, the grating element 120 can be incorporated into an optical disc drive device that plays the CD 17, the DVD 18 and the BD 19 and uses a laser unit in which a plurality of blue/red/infrared semiconductor lasers are integrated into one package as a light source. When the optical disc drive device uses the tracking method of not using the sub-spot for the BD 19 and uses the tracking method of using the sub-spot for the CD 17 and the DVD 18, for example, it is possible to form the main spot and the sub-spot on the CD 17 and the DVD 18 from a red laser beam and an infrared laser beam independently of each other without forming the sub-spot from a blue laser beam. Then, the blue laser beam is not substantially diffracted in the grating element 120. It thereby possible to suppress the degradation of the light use efficiency of the 0th order diffracted beam.

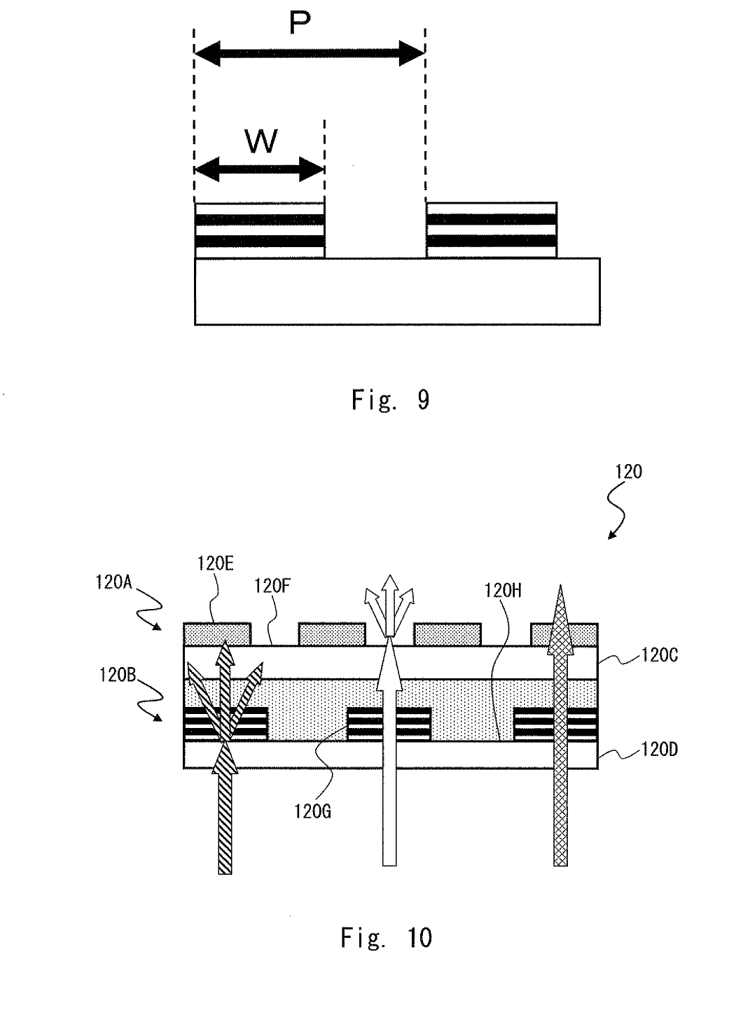

The grating element according to the present invention is applicable also to an optical disc drive device that uses two laser beams with different wavelengths. FIG. 11 shows a grating element 121 according to another example of the embodiment. The grating element 121 is applied to an optical disc drive device that uses two laser beams with different wavelengths.

As shown in FIG. 11, the grating element 121 includes a plurality of diffraction members 121A and 121B. In the diffraction member 121A, a protrusion 121E and a recess 121F are alternately arranged on the output surface of a transparent substrate 121C. Stated differently, the protrusion 121E and the recess 121F are arranged periodically on the output surface of the transparent substrate 121C of the diffraction member 121A. Likewise, a protrusion 121G and a recess 121H are arranged periodically on the input surface of a transparent substrate 121D of the diffraction member 121B. Further, the plurality of diffraction members 121A and 121B are bonded by together an adhesive material so that they are laminated in the direction substantially perpendicular to the transparent substrates 121C and 121D. Specifically, the input surface of the transparent substrate 121C and the output surface of the transparent substrate 121D are bonded by together an adhesive material. A material of the transparent substrates 121C and 121D is the same as that of the transparent substrates 12D, 12E and 12F and thus an explanation thereof is omitted.

Further, the protrusion 121E formed on the output surface of the transparent substrate 121C is made of a dielectric multilayer film. A material and a manufacturing process of the dielectric multilayer film are the same as those of the grating element 12 and thus an explanation thereof is omitted. Furthermore, a method of making the recess 121F of the transparent substrate 121C is the same as that of the recess 12H and the recess 12J and thus an explanation thereof is omitted.

Further, a method of making the protrusion 121G and the recess 121H of the transparent substrate 121D is the same as that of the protrusion 12K and the recess 12L of the transparent substrate 12F and thus an explanation thereof is omitted.

The function of the grating element 121 is described hereinafter with reference to FIG. 11. In FIG. 11, the arrow indicated by hatching and the open arrow respectively indicate laser beams of different wavelengths. The laser beam indicated by the arrow in hatching is diffracted by the diffraction member 120B at a predetermined diffraction efficiency and not substantially diffracted by the diffraction member 120A. Further, the laser beam indicated by the open arrow is diffracted by the diffraction member 120A at a predetermined diffraction efficiency and not substantially diffracted by the diffraction member 120B. Thus, the wavelengths of the laser beams that are diffracted at predetermined diffraction efficiencies by the plurality of diffraction members 120A and 120B are different from each other.

The grating element 120 having such a function may be used in an optical disc drive device that plays the CD 17 and the DVD 18 and uses a laser unit in which a plurality of red/infrared semiconductor lasers are integrated into one package as a light source, for example. Incorporation of the grating element 12 can form the main spot and the sub-spot on the CD 17 and the DVD 18 from laser beams emitted from the plurality of red/infrared semiconductor lasers independently of each other.

Further, as described earlier, the spectral ratio (I(+1)/I(0)) is preferably in the range of 0.05 to 0.10. Thus, in the grating element 121 according to the embodiment, d_{H} and d_{L} are set so as to satisfy the following expressions (3) and (4) when a phase shift amount added to a laser beam to be diffracted is φ_{D} and a phase shift amount added to a laser beam to be not substantially diffracted is φ_{ND}.

0.10<|φ_{D}|≦0.25 (3)

0.00≦|φ_{ND}|0.10 (4)

By satisfying the expression (3), the spectral ratio (I(+1)/I(0)) can be set in the range of 0.05 to 0.10 in the wavelength to be diffracted. It is thereby possible to prevent the degradation of a reproduced signal level and obtain a suitable tracking signal.

Further, by satisfying the expression (4), the intensity I(0) of the 0th order diffracted beam of the laser beam to be not substantially diffracted is larger than 90%. It is thereby possible to improve the light use efficiency of the 0th order diffracted beam of the laser beam to be not substantially diffracted.

Stated differently, the diffraction member 121A diffracts the laser beam indicated by the open arrow to the k-th order (k≠0) at a higher diffraction efficiency than the laser beam indicated by the arrow in hatching. Further, the diffraction member 121A does not substantially diffract the laser beam indicated by the arrow in hatching. Note that “not substantially diffracting the laser beam indicated by the arrow in hatching” means slightly diffracting the laser beam indicated by the arrow in hatching so that the intensity I(0) of the 0th order diffracted beam of the laser beam indicated by the arrow in hatching is larger than 90% of the intensity of the incident beam.

Likewise, the diffraction member 121B diffracts the laser beam indicated by the arrow in hatching to the k-th order (k≠0) at a higher diffraction efficiency than the laser beam indicated by the open arrow. Further, the diffraction member 121B does not substantially diffract the laser beam indicated by the open arrow. Note that “not substantially diffracting the laser beam indicated by the open arrow” means slightly diffracting the laser beam indicated by the open arrow so that the intensity I(0) of the 0th order diffracted beam of the laser beam indicated by the open arrow is larger than 90% of the intensity of the incident beam.

Further, in the grating element 121 according to the embodiment, when, in the diffraction member 121A having the protrusion 121E made of a dielectric multilayer film, a wavelength of a laser beam diffracted at a predetermined diffraction efficiency is λ_{D}, a wavelength of a laser beam not substantially diffracted is λ_{ND}, a refractive index of a high refractive index material at the wavelength λ_{ND} is n_{HND}, a refractive index of a low refractive index material at the wavelength λ_{ND} is n_{LND}, a refractive index of a medium in a space adjacent to the dielectric multilayer film is n_{0ND}, a total thickness of a dielectric film made of the high refractive index material is d_{H}, and a total thickness of a dielectric film made of the low refractive index material is d_{L}, it is preferred to set d_{H} and d_{L} so as to satisfy the following expressions (5) and (6).

$$\begin{matrix}\frac{0.5 {λ}_{ND}}{( {n}_{HND} - {n}_{0 ND} )} \leq {d}_{H} < \frac{{λ}_{ND}}{( {n}_{HND} - {n}_{0 ND} )} & ( 5 ) \\ {d}_{L} \leq \frac{{λ}_{ND} - ( {n}_{HND} - {n}_{0 ND} ) \times {d}_{H}}{( {n}_{LND} - {n}_{0 ND} )} & ( 6 )\end{matrix}$$

Patent Literature 1 describes that a depth of a groove is set in such a way that, when a laser beam with a different wavelength from a wavelength of a laser beam that diffracts a grating element passes, a phase difference between a light ray passing through an inter-groove part and a light ray passing through a groove part is 2π (one time the wavelength of the laser light). The depth of the groove varies depending on the refractive index of the grating element. However, in Patent Literature 1, approximate calculation according to the scalar diffraction theory represented by the following expressions (1) and (2) is performed.

2π·(n₁−1)·dᵢ/λ₁=2π (1)

η₁(0)=1 (2)

In the expression (1), η₁ is a refractive index of a grating element, d₁ is a depth of a groove, and λ₁ is a wavelength different from a wavelength of a laser beam that is diffracted by the grating element (a wavelength of a laser beam that is not substantially diffracted). Further, in the expression (2), η₁(0) is the light use efficiency of the 0th order diffracted beam of a laser beam.

Then, in the approximate calculation according to the scalar diffraction theory described in Patent Literature 1, when the laser beam with the wavelength λ₁ passes through the grating element, if a phase difference between a light ray passing through an inter-groove part and a light ray passing through a groove part is 2π (if the expression (1) is satisfied), the expression (2) is satisfied when the groove has any depth. Specifically, the diffraction efficiency η₁(0) of the laser beam with the wavelength λ₁ is 1 regardless of the duty ratio. Because the light use efficiency of the 0th order diffracted beam is 100% regardless of the duty ratio, the depth of the groove is irrelevant to the light use efficiency.

However, in strict calculation according to the vector diffraction theory using electromagnetic field analysis, a diffraction efficiency varies depending on the depth of the groove even if a phase difference between a light ray passing through an inter-groove part and a light ray passing through a groove part is 2π. Specifically, in the strict calculation according to the vector diffraction theory using electromagnetic field analysis, even if the expression (1) is satisfied, the expression (2) cannot be satisfied, and the light use efficiency of the 0th order diffracted beam does not reach 100%. The decrease in the light use efficiency is particularly significant in the grating element having a diffraction structure with a narrow pitch.

However, by determining the total thickness d_{H} of the dielectric film made of the high refractive index material and the total thickness d_{L} of the dielectric film made of the low refractive index material so as to satisfy the expressions (5) and (6), the light use efficiency of the 0th order diffracted beam calculated by the strict calculation can be improved. Specifically, by determining the height of the protrusion so as to satisfy the expressions (5) and (6), the light use efficiency of the 0th order diffracted beam calculated by the strict calculation can be improved.

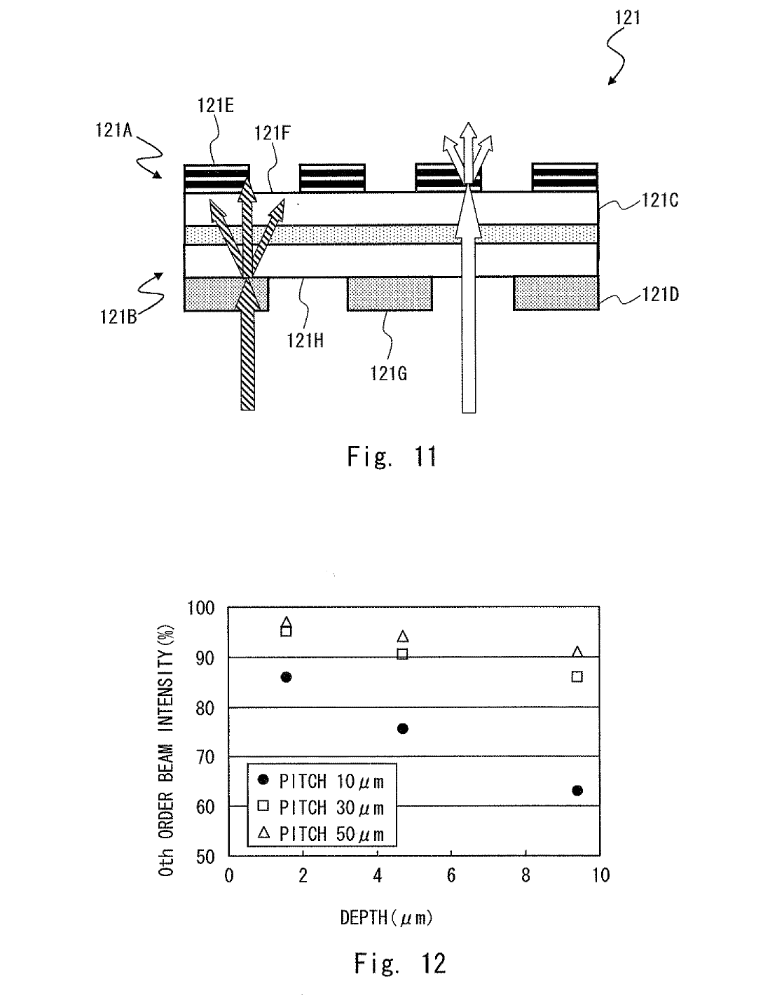

The graph of FIG. 12 shows a relationship between the light use efficiency of the 0th order diffracted beam of a laser beam with a wavelength of 0.785 μm and a grating depth. The grating element used in FIG. 12 is a transparent substrate having a protrusion-and-recess pattern on one surface and made of a single material. The refractive index of the grating element is 1.500. Further, in FIG. 12, the vertical axis indicates the intensity of the 0th order diffracted beam, and the horizontal axis indicates the depth of the grating (the height of the protrusion). Further, the intensity of the 0th order diffracted beam shown therein is when the intensity of an incident beam is 100%. Furthermore, the intensity of the diffracted beam is obtained by the strict calculation according to the finite-difference time-domain method (FDTD method). In FIG. 12, the open triangle mark indicates data when the pitch of the grating structure is 50 μm, the open square mark indicates data when the pitch of the grating structure is 30 μm, and the black circle mark indicates data when the pitch of the grating structure is 10 μm. Specifically, the intensity of the 0th order diffracted beam when the grating depth is 1.57 μm, 4.71 μm and 9.42 μm is plotted in FIG. 12. Note that the grating depths of 1.57 μm, 4.71 μm and 9.42 μm are depths that cause phase differences of 2π, 6π and 12π to be generated in the laser beam with the wavelength of 0.785 μm. In other words, the grating depths of 1.57 μm, 4.71 μm and 9.42 μm are depths that cause the laser beam with the wavelength of 0.785 μm to have phase differences of integral multiples of the wavelength. Thus, the grating depths of 1.57 μm, 4.71 μm and 9.42 μm do not cause a phase shift of the laser beam with the wavelength of 0.785 μm.

When the grating depth is a depth that causes a laser beam to have a phase difference of an integral multiple of a wavelength, the intensity of the 0th order diffracted beam is 100% by the approximate calculation according to the scalar diffraction theory. However, as shown in FIG. 12, by the strict calculation according to the vector diffraction theory (the strict calculation according to the FDTD method), the intensity of the 0th order diffracted beam does not reach 100% even when the grating depth is a depth that causes a laser beam to have a phase difference of an integral multiple of a wavelength. Further, as shown in FIG. 12, the decrease in the intensity of the 0th order diffracted beam is more significant as the pitch of the diffraction structure is narrower. Further, the decrease in the intensity of the 0th order diffracted beam is more significant as the grating depth is larger (as the height of the protrusion is higher).

Therefore, in order to improve the light use efficiency of the 0th order diffracted beam calculated by the strict calculation according to the vector diffraction theory, it is necessary to reduce the grating depth (reduce the height of the protrusion) and set the depth that causes a laser beam to be not diffracted to have a phase difference of an integral multiple of a wavelength.

The expressions (5) and (6) are conditions for reducing the height of the protrusion made of a dielectric multilayer film as much as possible and setting the height that causes a laser beam to be not diffracted to have a phase difference of an integral multiple of a wavelength. Therefore, by determining the total thickness d_{H} of the dielectric film made of the high refractive index material and the total thickness d_{L} of the dielectric film made of the low refractive index material so as to satisfy the expressions (5) and (6), it is possible to improve the light use efficiency of the 0th order diffracted beam calculated by the strict calculation. Specifically, by determining the height of the protrusion so as to satisfy the expressions (5) and (6), it is possible to improve the light use efficiency of the 0th order diffracted beam calculated by the strict calculation.

Note that, in the grating element 120 and the grating element 121, as in the grating element 12, the dielectric multilayer film is formed by alternate lamination of a dielectric film made of a high refractive index material and a dielectric film made of a low refractive index material. The dielectric multilayer film of the grating element 120 and the grating element 121 thereby has a function of preventing a laser beam incident on the dielectric multilayer film from being reflected by the dielectric multilayer film.

Further, in the grating element 120 and the grating element 121, as in the grating element 12, the number of layers of the dielectric multilayer film is determined in such a way that a reflectivity of a laser beam incident on the dielectric multilayer film by the dielectric multilayer film is low.

Furthermore, in the grating element 120 and the grating element 121, when the pitch of the grating structure is P and the width of the protrusions 120G and 121E is W, it is preferred to satisfy the following expression (7).

0.5<W/P<1.0 (7)

It is thereby possible to effectively suppress the reflection of a laser beam incident on the grating element 120 and the grating element 121. Specifically, it is preferred to select a duty (W/P) at which the reflectivity of a laser beam incident on the dielectric multilayer film by the dielectric multilayer film is 4% or below.

Further, a protrusion-and-recess pattern of one diffraction member may be formed on one surface of a transparent substrate and a protrusion-and-recess pattern of another diffraction member may be formed on the other surface of the transparent substrate, so that two kinds of diffraction members are integrally formed. It is thereby possible to eliminate the step of bonding the diffraction members and reduce the cost.

### EXAMPLE 1

An example of the grating element 12 shown in FIG. 2 is described as an example 1. There are three kinds of laser beams that pass through the grating element 12. The wavelengths of the three kinds of laser beams are 0.405 μm, 0.660 μm and 0.785 μm, respectively.

Further, the protrusion 12G of the diffraction member 12A and the protrusion 12I of the diffraction member 12B are made of a dielectric multilayer film. Further, the diffraction member 12C and the protrusion 12K of the diffraction member 12C are integrally formed using the same material. The diffraction member 12C and the protrusion 12K are made of quartz.

The diffraction wavelength of the diffraction member 12A is 0.405 μm, and the non-diffraction wavelength thereof is 0.660 μm and 0.785 μm. Further, the pitch (P) of the grating structure of the diffraction member 12A is 50 μm, and the duty (W/P) is 0.700. The height of the protrusion 12G (the grating depth: d) is 3.672 μm. The refractive index of the transparent substrate 12D of the diffraction member 12A is 1.530 at the wavelength of 0.405 μm, 1.514 at the wavelength of 0.660 μm, and 1.511 at the wavelength of 0.785 μm. Further, because a medium in a space adjacent to the protrusion 12G is air, the refractive index of the medium in the space adjacent to the protrusion 12G is 1.000.

The diffraction wavelength of the diffraction member 12B is 0.785 μm, and the non-diffraction wavelength thereof is 0.405 μm and 0.660 μm. Further, the pitch (P) of the grating structure of the diffraction member 12B is 60 μm, and the duty (W/P) is 0.583. The height of the protrusion 121 (the grating depth: d) is 1.300 μm. The refractive index of the transparent substrate 12E of the diffraction member 12B is 1.530 at the wavelength of 0.405 μm, 1.514 at the wavelength of 0.660 μm, and 1.511 at the wavelength of 0.785 μm. A medium in a space adjacent to the protrusion 121 is an adhesive material, and the refractive index of the adhesive material is 1.400 at the wavelength of 0.405 μm, 1.385 at the wavelength of 0.660 μm, and 1.382 at the wavelength of 0.785 μm.

The diffraction wavelength of the diffraction member 12C is 0.660 μm, and the non-diffraction wavelength thereof is 0.405 μm and 0.785 μm. Further, the pitch (P) of the grating structure of the diffraction member 12C is 50 μm, and the duty (W/P) is 0.500. The height of the protrusion 12K (the grating depth: d) is 1.645 μm. The refractive index of the transparent substrate 12F of the diffraction member 12C is 1.492 at the wavelength of 0.405 μm, 1.477 at the wavelength of 0.660 μm, and 1.475 at the wavelength of 0.785 μm. Further, the refractive index of the protrusion 12K is 1.492 at the wavelength of 0.405 μm, 1.477 at the wavelength of 0.660 μm, and 1.475 at the wavelength of 0.785 μm. Because a medium in a space adjacent to the protrusion 12K is air, the refractive index of the medium in the space adjacent to the protrusion 12K is 1.000.

The table in FIG. 13 shows the structure of the dielectric multilayer film that forms the protrusion 12G of the diffraction member 12A. Ta₂O₅ is used as the high refractive index material, and SiO₂ is used as the low refractive index material. Further, the number of layers of the dielectric multilayer film is sixteen. The total thickness d_{AH} of Ta₂O₅ is 3.483 μm, the total thickness d_{AL} of SiO₂ is 0.189 μm, and the height (the grating depth) d_{A} of the protrusion 12G is 3.672 μm.

When phase shift amounts that are added to the laser beams with the wavelengths of 0.405 μm, 0.660 μm and 0.785 μm by the diffraction member 12A are φ₄₀₅, φ₆₆₀ and φ₇₈₅, respectively,

### φ₄₀₅={(2.223−1.000)×3.483+(1.492−1.000)×0.189}/0.405−Round[{(2.223−1.000)×3.483+(1.492−1.000)×0.189}/0.405]=−0.2498(λ),

### φ₆₆₀={(2.108−1.000)×3.483+(1.477−1.000)×0.189}/0.660−Round[{(2.108−1.000)×3.483+(1.477−1.000)×0.189}/0.660]=−0.0170(λ), and

φ₇₈₅={(2.093−1.000)×3.483+(1.475−1.000)×0.189}/0.785−Round[{(2.093−1.000)×3.483+(1.475−1.000)×0.189}/0.785]=−0.0367(λ) from the expression (8).
Specifically, the phase shift amount φ₄₀₅ that is added to the laser beam with the wavelength of 0.405 μm by the diffraction member 12A is −0.2498(λ), which satisfies the expression (3). Further, the phase shift amounts φ₆₆₀ and φ₇₈₅ that are added to the laser beam with the wavelength of 0.660 μm and the laser beam with the wavelength of 0.785 μm by the diffraction member 12A are −0.0170(λ) and −0.0367(λ), respectively, which satisfy the expression (4).

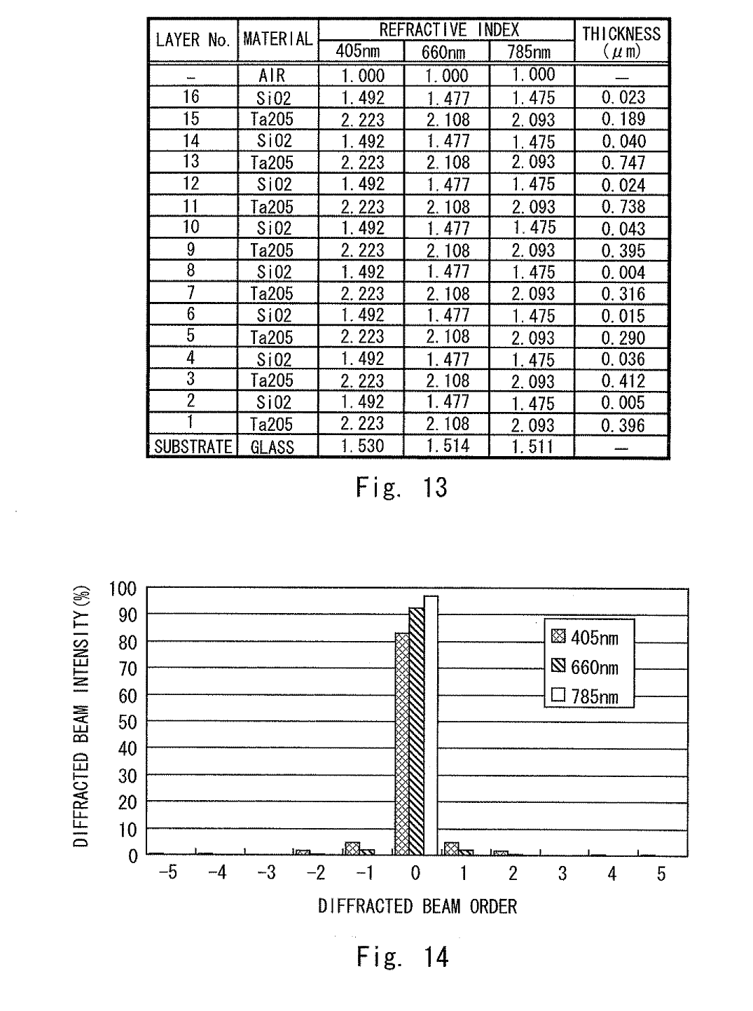

FIG. 14 shows the intensity of a diffracted beam when the laser beams with the wavelengths of 0.405 μm, 0.660 μm and 0.785 μm are diffracted by the diffraction member 12A. In the graph of FIG. 14, the horizontal axis indicates the diffraction order, and the vertical axis indicates the intensity of a diffracted beam. In the graph of FIG. 14, the bar indicated by cross-hatching indicates the intensity of a diffracted beam of the laser beam with the wavelength of 0.405 μm. Further, in the graph of FIG. 14, the bar indicated by hatching indicates the intensity of a diffracted beam of the laser beam with the wavelength of 0.660 μm. Furthermore, in the graph of FIG. 14, the open bar indicates the intensity of a diffracted beam of the laser beam with the wavelength of 0.785 μm.

The intensities of diffracted beams are obtained by the strict calculation according to the finite-difference time-domain method (FDTD method). In FIG. 14, the intensity of a diffracted beam at each diffraction order when the intensity of an incident beam is 100% is shown.

As shown in FIG. 14, the spectral ratio (the intensity of the ±1st order diffracted beam/the intensity of the 0th order diffracted beam) of the laser beam with the wavelength of 0.405 μm is 1/17.2, which is within the range of 0.05 to 0.1. Further, the intensities of the 0th order diffracted beams of the laser beams with the wavelengths of 0.660 μm and 0.785 μm are 92.4% and 97.0%, respectively. Therefore, the diffraction member 12A according to the example 1 can diffract the laser beam with the wavelength of 0.405 μm, which should be diffracted, at a suitable spectral ratio. Further, the diffraction member 12A according to the example 1 can allow the laser beams with the wavelengths of 0.660 μm and 0.785 μm, which should not be diffracted, to pass through without substantially diffracting them.

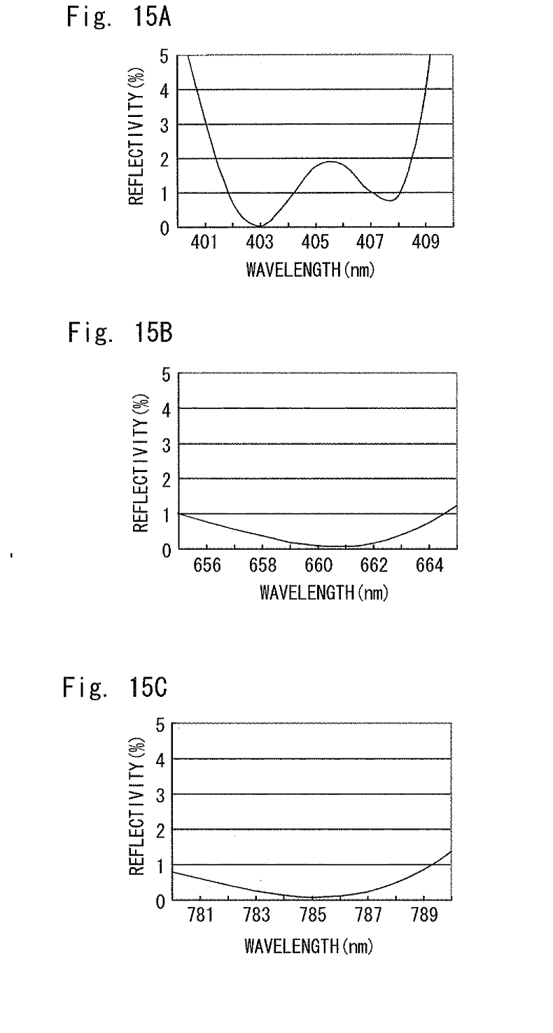

FIGS. 15A to 15C show a wavelength dependence of the reflectivity of the dielectric multilayer film that forms the protrusion 12G of the diffraction member 12A. In the graphs shown in FIGS. 15A to 15C, the horizontal axis indicates a wavelength (nm), and the vertical axis indicates a reflectivity (%). The reflectivity is the ratio of the intensity of a laser beam reflected by the dielectric multilayer film to the intensity of a laser beam incident on the dielectric multilayer film.

As shown in FIG. 15A, 15B and 15C, the reflectivity at the wavelengths of 0.405 μm, 0.660 μm and 0.785 μm is 2% or less. Therefore, the dielectric multilayer film of the diffraction member 12A has an antireflection function. Further, the duty of the diffraction member 12A is 0.700, so that the proportion of the protrusion 12G on the surface of the diffraction member 12A can be large. It is thereby possible to effectively suppress the reflection of a laser beam incident on the diffraction member 12A. There is thus no need to provide an antireflection film on the diffraction member 12A. Note that an antireflection film may be deposited on the surface of the diffraction member 12A to further enhance the antireflection function.

The table shown in FIG. 16 shows the structure of the dielectric multilayer film that forms the protrusion 12I of the diffraction member 12B. Ta₂O₅ is used as the high refractive index material, and SiO₂ is used as the low refractive index material. Further, the number of layers of the dielectric multilayer film is twelve. The total thickness d_{BH} of Ta₂O₅ is 0.900 μm, the total thickness d_{BL} of SiO₂ is 0.400 μm, and the height (the grating depth) dB of the protrusion 12I is 1.300 μm.

When phase shift amounts that are added to the laser beams with the wavelengths of 0.405 μm, 0.660 μm and 0.785 μm by the diffraction member 12B are φ₄₀₅, φ₆₆₀ and φ₇₈₅, respectively,

### φ₄₀₅={(2.223−1.400)×0.900+(1.492−1.400)×0.400}/0.405−Round[{(2.223−1.400)×0.900+(1.492−1.400)×0.400}/0.405=]−0.079(λ),

### φ₆₆₀={(2.108−1.385)×0.900+(1.477−1.385)×0.400}/0.660−Round[{(2.108−1.385)×0.900+(1.477−1.385)×0.400}/0.660]=+0.042(λ), and

φ₇₈₅={(2.093−1.382)×0.900+(1.475−1.382)×0.400}/0.785−Round[{(2.093−1.382)×0.900+(1.475−1.382)×0.400}/0.785]=−0.137(λ) from the expression (8).
Specifically, the phase shift amount φ₇₈₅ that is added to the laser beam with the wavelength of 0.785 μm by the diffraction member 12B is −0.137(λ), which satisfies the expression (3). Further, the phase shift amounts φ₄₀₅ and φ₆₆₀ that are added to the laser beam with the wavelength of 0.405 μm and the laser beam with the wavelength of 0.660 μm by the diffraction member 12B are −0.079(λ) and +0.042(λ), respectively, which satisfy the expression (4).

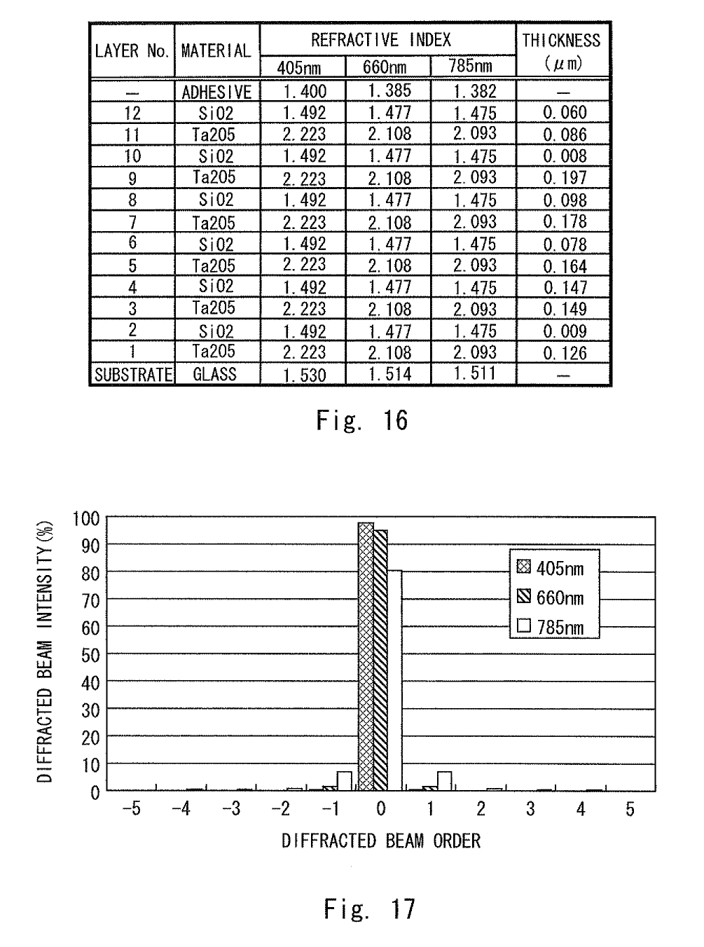

FIG. 17 shows the intensity of a diffracted beam when the laser beams with the wavelengths of 0.405 μm, 0.660 μm and 0.785 μm are diffracted by the diffraction member 12B. In the graph of FIG. 17, the horizontal axis indicates the diffraction order, and the vertical axis indicates the intensity of a diffracted beam. In the graph of FIG. 17, the bar indicated by cross-hatching indicates the intensity of a diffracted beam of the laser beam with the wavelength of 0.405 μm. Further, in the graph of FIG. 17, the bar indicated by hatching indicates the intensity of a diffracted beam of the laser beam with the wavelength of 0.660 μm. Furthermore, in the graph of FIG. 17, the open bar indicates the intensity of a diffracted beam of the laser beam with the wavelength of 0.785 μm.

The intensities of diffracted beams are obtained by the strict calculation according to the finite-difference time-domain method (FDTD method). In FIG. 17, the intensity of a diffracted beam at each diffraction order when the intensity of an incident beam is 100% is shown.

As shown in FIG. 17, the spectral ratio (the intensity of the ±1st order diffracted beam/the intensity of the 0th order diffracted beam) of the laser beam with the wavelength of 0.785 μm is 1/11.6, which is within the range of 0.05 to 0.1. Further, the intensities of the 0th order diffracted beams of the laser beams with the wavelengths of 0.405 μm and 0.660 μm are 97.7% and 94.9%, respectively. Therefore, the diffraction member 12B according to the example 1 can diffract the laser beam with the wavelength of 0.785 μm, which should be diffracted, at a suitable spectral ratio. Further, the diffraction member 12B according to the example 1 can allow the laser beams with the wavelengths of 0.405 μm and 0.660 μm, which should not be diffracted, to pass through without substantially diffracting them.

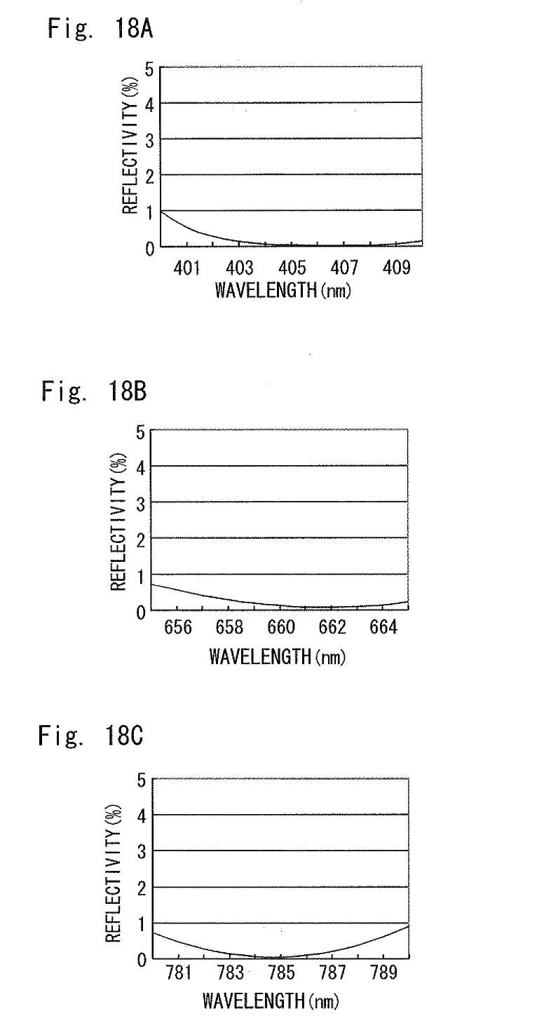

FIGS. 18A to 18C show a wavelength dependence of the reflectivity of the dielectric multilayer film that forms the protrusion 12I of the diffraction member 12B. In the graphs shown in FIGS. 18A to 18C, the horizontal axis indicates a wavelength (nm), and the vertical axis indicates a reflectivity (%). The reflectivity is the ratio of the intensity of a laser beam reflected by the dielectric multilayer film to the intensity of a laser beam incident on the dielectric multilayer film.

As shown in FIGS. 18A, 18B and 18C, the reflectivity at the wavelengths of 0.405 μm, 0.660 μm and 0.785 μm is 1% or less. Therefore, the dielectric multilayer film of the diffraction member 12B has an antireflection function. Further, the duty of the diffraction member 12B is 0.583, so that the proportion of the protrusion 121 on the surface of the diffraction member 12B can be large. It is thereby possible to effectively suppress the reflection of a laser beam incident on the diffraction member 12B. There is thus no need to provide an antireflection film on the diffraction member 12B. Note that an antireflection film may be deposited on the surface of the diffraction member 12B to further enhance the antireflection function.

The diffraction member 12C is made of one kind of material. Therefore, when the refractive index of the diffraction member 12C is n, the refractive index of a medium in a space adjacent to the protrusion 12K is n₀, the height of the protrusion 12K (grating depth) is d, and the wavelength of a laser beam is λ, a phase shift amount φ that is added to the laser beam with the wavelength λ by the diffraction member 12C is represented by the following expression (9).

φ=d×(n−n₀)/λ−Round(d×(n−n₀)/λ) (9)

Therefore, when phase shift amounts that are added to the laser beams with the wavelengths of 0.405 μm, 0.660 μm and 0.785 μm by the diffraction member 12C are φ₄₀₅, φ₆₆₀ and φ₇₈₅, respectively,

### φ₄₀₅=1.645×(1.492−1.000)/0.405−Round[1.645 ×(1.492−1.000)/0.405]=−0.002(λ),

### φ₆₆₀=1.645×(1.477−1.000)/0.660−Round[1.645 ×(1.477−1.000)/0.660]=+0.189(λ), and

### φ₇₈₅=1.645×(1.475−1.000)/0.785−Round[1.645×(1.475−1.000)/0.785]=−0.005(λ)

from the expression (9). Specifically, the phase shift amount φ₆₆₀ that is added to the laser beam with the wavelength of 0.660 μm by the diffraction member 12C is +0.189(λ), which satisfies the expression (3). Further, the phase shift amounts φ₄₀₅ and φ₇₈₅ that are added to the laser beam with the wavelength of 0.405 μm and the laser beam with the wavelength of 0.785 μm by the diffraction member 12C are −0.002(λ) and −0.005(λ), respectively, which satisfy the expression (4).

FIG. 19 shows the intensity of a diffracted beam when the laser beams with the wavelengths of 0.405 μm, 0.660 μm and 0.785 μm are diffracted by the diffraction member 12C. In the graph of FIG. 19, the horizontal axis indicates the diffraction order, and the vertical axis indicates the intensity of a diffracted beam. In the graph of FIG. 19, the bar indicated by cross-hatching indicates the intensity of a diffracted beam of the laser beam with the wavelength of 0.405 μm. Further, in the graph of FIG. 19, the bar indicated by hatching indicates the intensity of a diffracted beam of the laser beam with the wavelength of 0.660 μm. Furthermore, in the graph of FIG. 19, the open bar indicates the intensity of a diffracted beam of the laser beam with the wavelength of 0.785 μm.

The intensities of diffracted beams are obtained by the strict calculation according to the finite-difference time-domain method (FDTD method). In FIG. 19, the intensity of a diffracted beam at each diffraction order when the intensity of an incident beam is 100% is shown.

As shown in FIG. 19, the spectral ratio (the intensity of the ±1st order diffracted beam/the intensity of the 0th order diffracted beam) of the laser beam with the wavelength of 0.660 μm is 1/14.3, which is within the range of 0.05 to 0.1. Further, the intensities of the 0th order diffracted beams of the laser beams with the wavelengths of 0.405 μm and 0.785 μm are 97.1% and 96.9%, respectively. Therefore, the diffraction member 12C according to the example 1 can diffract the laser beam with the wavelength of 0.660 μm, which should be diffracted, at a suitable spectral ratio. Further, the diffraction member 12C according to the example 1 can allow the laser beams with the wavelengths of 0.405 μm and 0.785 μm, which should not be diffracted, to pass through without substantially diffracting them.

Note that, when made of one kind of material such as the diffraction member 12C, it is preferred to deposit an antireflection film on the surface of the diffraction member 12C.

Then, as shown in FIG. 1, the diffraction members 12A, 12B and 12C according to the example 1 are bonded together, thereby obtaining the grating element 12 that can diffract the laser beams with the wavelengths of 0.405 μm, 0.660 μm and 0.785 μm at suitable diffraction efficiencies independently of one another.

### EXAMPLE 2

An example of the grating element 121 shown in FIG. 11 is described as an example 2. There are two kinds of laser beams that pass through the grating element 121. The wavelengths of the two kinds of laser beams are 0.660 μm and 0.785 μm, respectively.

Further, the protrusion 121E of the diffraction member 121A is made of a dielectric multilayer film. Furthermore, the protrusion 121G of the diffraction member 121B is made of acrylic resin.

The diffraction wavelength of the diffraction member 121A is 0.660 μm, and the non-diffraction wavelength thereof is 0.785 μm. Further, the pitch (P) of the grating structure of the diffraction member 121A is 15 μm, and the duty (W/P) is 0.800. The height of the protrusion 121E (the grating depth: d) is 0.760 μm. The refractive index of the transparent substrate 121C of the diffraction member 121A is 1.514 at the wavelength of 0.660 μm, and 1.511 at the wavelength of 0.785 μm. Further, because a medium in a space adjacent to the protrusion 121E is air, the refractive index of the medium in the space adjacent to the protrusion 121E is 1.000.

The diffraction wavelength of the diffraction member 121B is 0.785 μm, and the non-diffraction wavelength thereof is 0.660 μm. Further, the pitch (P) of the grating structure of the diffraction member 121B is 35 μm, and the duty (W/P) is 0.24. The height of the protrusion 121G (the grating depth: d) is 1.320 μm. The refractive index of the transparent substrate 121D of the diffraction member 121B is 1.514 at the wavelength of 0.660 μm and 1.511 at the wavelength of 0.785 μm. Further, the refractive index of the protrusion 121G is 1.500 at the wavelength of 0.660 μm and 1.497 at the wavelength of 0.785 μm. Because a medium in a space adjacent to the protrusion 121G is air, the refractive index of the medium in the space adjacent to the protrusion 121G is 1.000.

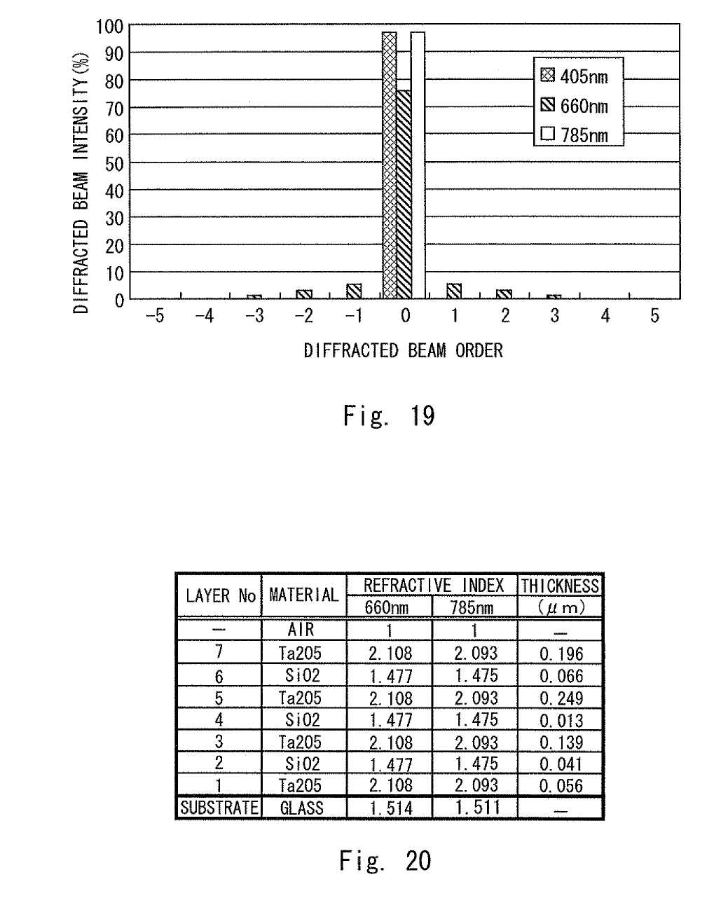

The table in FIG. 20 shows the structure of the dielectric multilayer film that forms the protrusion 121E of the diffraction member 121A. Ta₂O₅ is used as the high refractive index material, and SiO₂ is used as the low refractive index material. Further, the number of layers of the dielectric multilayer film is seven. The total thickness d_{FH} of Ta₂O₅ is 0.640 μm, the total thickness d_{FL} of SiO₂ is 0.120 μm, and the height (the grating depth) d_{F} of the protrusion 121E is 0.760 μm. In the protrusion 121E of the diffraction member 121A, because λ_{ND}=0.785 μm, n_{HND}=2.093, n_{LND}=1.475 and n_{0ND}=1.000, d_{L}≦0.180 μm from the expression (5), and 0.359 μm≦d_{H}<0.718 μm from the expression (6). Therefore, the total thickness d_{FH} of Ta₂O₅ and the total thickness d_{FL} of SiO₂ satisfy the expressions (5) and (6).

Further, when phase shift amounts that are added to the laser beams with the wavelengths of 0.660 μm and 0.785 μm by the diffraction member 121A are φ₆₆₀ and φ₇₈₅, respectively,

### φ₆₆₀={(2.108−1.000)×0.640+(1.477−1.000)×0.120}/0.660−Round[{(2.108−1.000)×0.640+(1.477−1.000)×0.120}/0.660]=+0.161(λ), and

φ₇₈₅={(2.093−1.000)×0.640+(1.475−1.000)×0.120}/0.785−Round[{(2.093−1.000)×0.640+(1.475−1.000)×0.120}/0.785]=−0.036(λ) from the expression (8).
Specifically, the phase shift amount φ₆₆₀ that is added to the laser beam with the wavelength of 0.660 μm by the diffraction member 121A is +0.161(λ), which satisfies the expression (3). Further, the phase shift amount φ₇₈₅ that is added to the laser beam with the wavelength of 0.785 μm by the diffraction member 121A are −0.036(λ), which satisfies the expression (4).

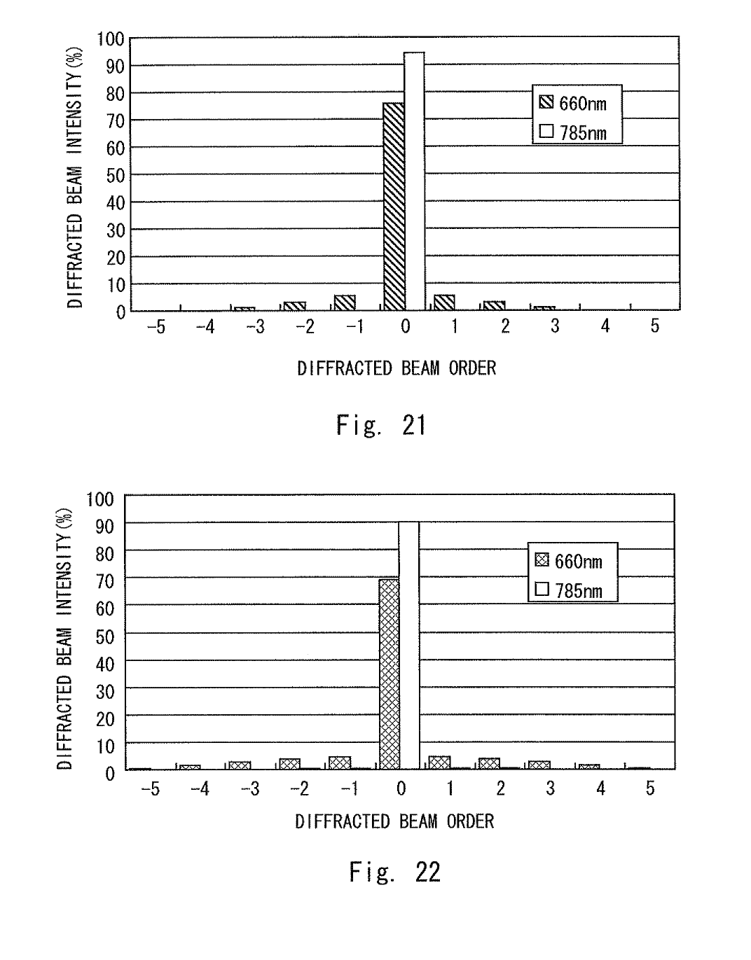

FIG. 21 shows the intensity of a diffracted beam when the laser beams with the wavelengths of 0.660 μm and 0.785 μm are diffracted by the diffraction member 121A. In the graph of FIG. 21, the horizontal axis indicates the diffraction order, and the vertical axis indicates the intensity of a diffracted beam. In the graph of FIG. 21, the bar indicated by hatching indicates the intensity of a diffracted beam of the laser beam with the wavelength of 0.660 μm. Further, in the graph of FIG. 21, the open bar indicates the intensity of a diffracted beam of the laser beam with the wavelength of 0.785 μm.

The intensities of diffracted beams are obtained by the strict calculation according to the finite-difference time-domain method (FDTD method). In FIG. 21, the intensity of a diffracted beam at each diffraction order when the intensity of an incident beam is 100% is shown.

As shown in FIG. 21, the spectral ratio (the intensity of the ±1st order diffracted beam/the intensity of the 0th order diffracted beam) of the laser beam with the wavelength of 0.660 μm is 1/14.2, which is within the range of 0.05 to 0.1. Further, the intensity of the 0th order diffracted beam of the laser beam with the wavelength 0.785 μm is 94.2%. Therefore, the diffraction member 121A according to the example 2 can diffract the laser beam with the wavelength of 0.660 μm, which should be diffracted, at a suitable spectral ratio. Further, the diffraction member 121A according to the example 2 can allow the laser beam with the wavelength of 0.785 μm, which should not be diffracted, to pass through without substantially diffracting it.

For comparison, a diffraction grating which is used hitherto (which is referred to hereinafter as a hitherto used diffraction grating) that has a diffracting structure with the same pitch as the diffraction member 121A and made of a single material is described by way of illustration. The diffraction wavelength of the hitherto used diffraction grating is 0.660 μm, and the non-diffraction wavelength thereof is 0.785 μm. Further, the pitch (P) of the grating structure of the hitherto used diffraction grating is 15 μm, and the duty (W/P) is 0.873. The height of a protrusion (the grating depth: d) of the hitherto used diffraction grating is 1.654 μm. The refractive index of a transparent substrate of the hitherto used diffraction grating is 1.477 at the wavelength of 0.660 μm and 1.475 at the wavelength of 0.785 μm. Further, the refractive index of the protrusion of the hitherto used diffraction grating is 1.477 at the wavelength of 0.660 μm and 1.475 at the wavelength of 0.785 μm. Because a medium in a space adjacent to the protrusion of the hitherto used diffraction grating is air, the refractive index of the medium in the space adjacent to the protrusion is 1.000.

FIG. 22 shows the intensity of a diffracted beam when the laser beams with the wavelengths of 0.660 μm and 0.785 μm are diffracted by the hitherto used diffraction grating. In the graph of FIG. 22, the horizontal axis indicates the diffraction order, and the vertical axis indicates the intensity of a diffracted beam. In the graph of FIG. 22, the bar indicated by hatching indicates the intensity of a diffracted beam of the laser beam with the wavelength of 0.660 μm. Further, in the graph of FIG. 22, the open bar indicates the intensity of a diffracted beam of the laser beam with the wavelength of 0.785 μm.

The intensities of diffracted beams are obtained by the strict calculation according to the finite-difference time-domain method (FDTD method). In FIG. 22, the intensity of a diffracted beam at each diffraction order when the intensity of an incident beam is 100% is shown.

As shown in FIG. 22, the spectral ratio (the intensity of the ±1st order diffracted beam/the intensity of the 0th order diffracted beam) of the laser beam with the wavelength of 0.660 μm is 1/15.3, which is within the range of 0.05 to 0.1. Further, the intensity of the 0th order diffracted beam of the laser beam with the wavelength 0.785 μm is 90.1%. Comparing FIG. 21 with FIG. 22, the diffraction member 121A according to the example 2 can diffract the laser beam with the wavelength of 0.660 μm, which should be diffracted, at a higher spectral ratio than the hitherto used diffraction grating. Further, the diffraction member 121A according to the example 2 can improve the intensity of the 0th order diffracted beam of the laser beam with the wavelength of 0.785 which should not be diffracted, compared to the hitherto used diffraction grating. Therefore, the diffraction member 121A according to the example 2 can diffract the laser beam which should be diffracted at a higher diffraction efficiency and allow the laser beam which should not be diffracted to pass through with less diffraction compared to the hitherto used diffraction grating.

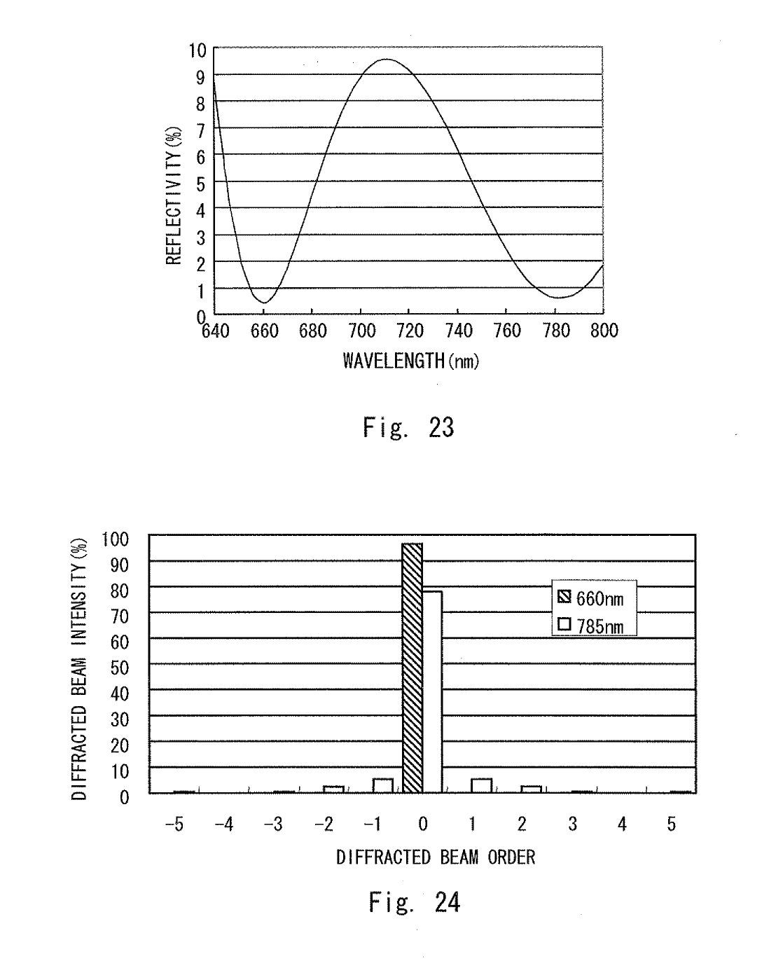

FIG. 23 shows a wavelength dependence of the reflectivity of the dielectric multilayer film that forms the protrusion 121E of the diffraction member 121A. In the graphs shown in FIG. 23, the horizontal axis indicates a wavelength (nm), and the vertical axis indicates a reflectivity (%). The reflectivity is the ratio of the intensity of a laser beam reflected by the dielectric multilayer film to the intensity of a laser beam incident on the dielectric multilayer film.

As shown in FIG. 23, the reflectivity at the wavelengths of 0.660 μm and 0.785 μm is 1% or less. Therefore, the dielectric multilayer film of the diffraction member 121A has an antireflection function. Further, the duty of the diffraction member 121A is 0.800, so that the proportion of the protrusion 121E on the surface of the diffraction member 121A can be large. It is thereby possible to effectively suppress the reflection of a laser beam incident on the diffraction member 121A. There is thus no need to provide an antireflection film on the diffraction member 121A. Note that an antireflection film may be deposited on the surface of the diffraction member 121A to further enhance the antireflection function.

FIG. 24 shows the intensity of a diffracted beam when the laser beams with the wavelengths of 0.660 μm and 0.785 μm are diffracted by the diffraction member 121B. In the graph of FIG. 24, the horizontal axis indicates the diffraction order, and the vertical axis indicates the intensity of a diffracted beam. In the graph of FIG. 24, the bar indicated by hatching indicates the intensity of a diffracted beam of the laser beam with the wavelength of 0.660 μm. Further, in the graph of FIG. 24, the open bar indicates the intensity of a diffracted beam of the laser beam with the wavelength of 0.785 μm.

The intensities of diffracted beams are obtained by the strict calculation according to the finite-difference time-domain method (FDTD method). In FIG. 24, the intensity of a diffracted beam at each diffraction order when the intensity of an incident beam is 100% is shown.

As shown in FIG. 24, the spectral ratio (the intensity of the ±1st order diffracted beam/the intensity of the 0th order diffracted beam) of the laser beam with the wavelength of 0.785 μm is 1/15.4, which is within the range of 0.05 to 0.1. Further, the intensity of the 0th order diffracted beam of the laser beam with the wavelength 0.660 μm is 96.5%. Therefore, the diffraction member 121B according to the example 2 can diffract the laser beam with the wavelength of 0.785 μm, which should be diffracted, at a suitable spectral ratio. Further, the diffraction member 121B according to the example 2 can allow the laser beam with the wavelength of 0.660 μm, which should not be diffracted, to pass through without substantially diffracting it.

Then, as shown in FIG. 11, the diffraction members 121A and 121B according to the example 2 are bonded together, thereby obtaining the grating element 121 that can diffract the laser beams with the wavelengths of 0.660 μm and 0.785 μm at suitable diffraction efficiencies independently of each other.

According to the grating element 12, the optical pickup optical system 1 and the method of designing the grating element 12 described above, the protrusions 12G and 12I of the diffraction members are made of a dielectric multilayer film, so that the wavelengths of laser beams that are diffracted at predetermined diffraction efficiencies by the plurality of diffraction members 12A, 12B and 12C constituting the grating element 12 can be different from one another.

The grating element 12 can thereby diffract three laser beams with different wavelengths in a suitable manner. It is thereby possible to split the three laser beams with different wavelengths to be the main spot and the sub-spot in a suitable manner.

Further, the grating elements 120 and 121 according to the present invention have the two diffraction members 120A and 120B, and 121A and 121B, respectively, which are laminated in the substantially perpendicular direction to the transparent substrates 120C and 120D, and 121C and 121D.

The grating elements 120 and 121 can thereby diffract two laser beams with different wavelengths in a suitable manner.

Further, in the diffraction members 12A, 12B, 120A and 121A in which the protrusions 12G, 12I, 120E and 121E are made of a dielectric multilayer film, when a phase shift amount added to a laser beam to be diffracted at a predetermined diffraction efficiency is φ_{D} and a phase shift amount added to a laser beam to be not substantially diffracted is φ_{ND}, the following expressions (3) and (4) are satisfied.

0.10<|φ_{D}|≦0.25 (3)

0.00≦|φ_{ND}|≦0.10 (4)

By satisfying the expressions (3) and (4), the spectral ratio is (the intensity of a diffracted beam at a certain order/the intensity of the 0th order diffracted beam) of the laser beam to be diffracted at the predetermined diffraction efficiency can be about 0.05 to 0.10. If the value of the spectral ratio is smaller than 0.05, the intensity of a sub-spot decreases, which makes it difficult to obtain a suitable tracking signal. On the other hand, if the spectral ratio is larger than 0.1, the intensity of a main spot decreases, which causes a degradation of a reproduced signal level.

Specifically, as a phase shift amount added to a laser beam by a grating element increases, the intensity of the 0th order diffracted beam decreases, and the spectral ratio changes largely according to a change in the duty (the ratio of the width of a protrusion to the pitch of a grating structure of a diffraction member). Therefore, to obtain a desired spectral ratio, the intensity of the 0th order diffracted beam decreases, which leads to a degradation of a reproduced signal level. On the other hand, when the phase shift amount φ decreases, while the intensity of the 0th order diffracted beam increases, the spectral ratio is difficult to change even with a change in the duty, so that it is difficult to obtain a desired spectral ratio at any duty (W/P).

Therefore, by satisfying the expressions (3) and (4), it is possible to obtain a suitable tracking signal and prevent the degradation of a reproduced signal level.

Further, it is preferred that the dielectric multilayer film is formed by lamination of a dielectric film made of a high refractive index material and a dielectric film made of a low refractive index material. Furthermore, in the diffraction members 120A and 121A having the protrusions 120E and 121E made of a dielectric multilayer film, when the wavelength of a laser beam diffracted at a predetermined diffraction efficiency is λ_{D}, the wavelength of a laser beam not substantially diffracted is λ_{ND}, the refractive index of the high refractive index material at the wavelength λ_{ND} is n_{HND}, the refractive index of the low refractive index material at the wavelength λ_{ND} is n_{LND}, the refractive index of a medium in a space adjacent to the dielectric multilayer film is n_{0ND}, the total thickness of the dielectric film made of the high refractive index material is d_{H}, and the total thickness of the dielectric film made of the low refractive index material is d_{L}, it is preferred to satisfy the following expressions (5) and (6).

$$\begin{matrix}\frac{0.5 {λ}_{ND}}{( {n}_{HND} - {n}_{0 ND} )} \leq {d}_{H} < \frac{{λ}_{ND}}{( {n}_{HND} - {n}_{0 ND} )} & ( 5 ) \\ {d}_{L} \leq \frac{{λ}_{ND} - ( {n}_{HND} - {n}_{0 ND} ) \times {d}_{H}}{( {n}_{LND} - {n}_{0 ND} )} & ( 6 )\end{matrix}$$

By determining the heights of the protrusions 120E and 121E so as to satisfy the following expressions (5) and (6), it is possible to improve the light use efficiency of the 0th order diffracted beam that is calculated by the strict calculation.

Furthermore, it is preferred that the dielectric multilayer film is formed by alternate lamination of a dielectric film made of a high refractive index material and a dielectric film made of a low refractive index material.

In such a structure, it is possible to suppress the reflection of a laser beam incident on the dielectric multilayer film. This reduces the return light to a light source. It is thereby possible to avoid the interference of the return light in a laser resonator to cause fluctuations of the laser output. It is thus possible to suppress laser noise.

Further, because the reflection of a laser beam can be suppressed, it is possible to allow a laser beam to pass at a high efficiency. In other words, it is possible to improve the light use efficiency.

It is also preferred that a reflectivity which is a rate that a laser beam incident on a dielectric multilayer film is reflected by the dielectric multilayer film is 4% or below.

It is thereby possible to sufficiently suppress the laser noise. It is further possible to improve the light use efficiency.

Further, in the diffraction members 12A, 12B, 120A and 121A in which the protrusions 12G, 12I, 120E and 121E are made of a dielectric multilayer film, when the pitch of the grating structure of the diffraction members 12A, 12B, 120A and 121A is P and the width of the protrusions 12G, 12I, 120E and 121E is W, it is preferred to satisfy the following expression (7).

0.5<W/P<1.0 (7)

The width of the protrusions 12G, 12I, 120E and 121E having an antireflection function can be thereby larger than the width of the recesses 12H, 12J, 120F and 121F having no antireflection function. Accordingly, the proportion of the protrusions 12G, 12I, 120E and 121E on the surfaces of the grating elements 12, 120 and 121, respectively, can be large. It is thereby possible to effectively suppress the reflection of a laser beam incident on the grating elements 12, 120 and 121.

Furthermore, it is preferred that the plurality of diffraction members 12A, 12B and 12C, 120A and 120B, and 121A and 121B are respectively bonded together by an adhesive material.

It is thereby possible to prevent the displacement of the diffraction members 12A, 12B and 12C, 120A and 120B, and 121A and 121B in the grating elements 12, 120 and 121. Further, by using an adhesive material having a desired refractive index as the adhesive material, it is possible to set the diffraction efficiencies and the 0th order diffracted beam use efficiencies of the grating elements 12, 120 and 121 to suitable values.

### INDUSTRIAL APPLICABILITY

It is possible to split three or more laser beams with different wavelengths to be a main spot and a sub-spot in a suitable manner.

### REFERENCE SIGNS LIST

1 OPTICAL PICKUP OPTICAL SYSTEM
11 LASER UNIT (LIGHT SOURCE)
111 CD LASER LIGHT SOURCE
112 DVD LASER LIGHT SOURCE
113 BD LASER LIGHT SOURCE
12, 120, 121 GRATING ELEMENT (OPTICAL ELEMENT)
12A, 12B, 12C, 120A, 120B, 121A, 121B DIFFRACTION MEMBER
12D, 12E, 12F, 120C, 120D, 121C, 121D TRANSPARENT SUBSTRATE
12G, 12I, 12K, 120E, 120G, 121E, 121G PROTRUSION
12H, 12J, 12L, 120F, 120H, 121F, 121H RECESS
17 CD
18 DVD
19 BD

1. A grating element comprising:
a plurality of diffraction members each comprising a protrusion and a recess arranged periodically on one surface of a transparent substrate, wherein
the plurality of diffraction members are laminated in a substantially perpendicular direction to the transparent substrate,
the protrusion of at least one diffraction member of the plurality of diffraction members is made of a dielectric multilayer film,
the dielectric multilayer film has dielectric films of two or more types laminated in the substantially perpendicular direction on the transparent substrate, and
wavelengths of laser beams diffracted at predetermined diffraction efficiencies by the plurality of diffraction members are different from one another.

2. The grating element according to claim 1, wherein three diffraction members are laminated in the substantially perpendicular direction.

3. The grating element according to claim 1, wherein two diffraction members are laminated in the substantially perpendicular direction.

4. The grating element according to claim 1, wherein, in the diffraction member with the protrusion made of the dielectric multilayer film, when a phase shift amount added to a laser beam to be diffracted at the predetermined diffraction efficiency is φ_{D} and a phase shift amount added to a laser beam to be not substantially diffracted is φ_{ND}, following expressions and are satisfied:
0.10<|φ_{D}|≦0.25,
0.00≦|φ_{ND}|≦0.10.

5. The grating element according to claim 3, wherein, in the diffraction member with the protrusion made of the dielectric multilayer film, when a phase shift amount added to a laser beam to be diffracted at the predetermined diffraction efficiency is φ_{D} and a phase shift amount added to a laser beam to be not substantially diffracted is φ_{ND}, following expressions and are satisfied:
0.10<|φ_{D}≦0.25,
0.00≦|φ_{ND}|≦0.10.

6. The grating element according to claim 3, wherein
the dielectric multilayer film is formed by lamination of the dielectric film made of a high refractive index material and the dielectric film made of a low refractive index material, and
in the diffraction member with the protrusion made of the dielectric multilayer film, when a wavelength of a laser beam diffracted at the predetermined diffraction efficiency is λ_{D}, a wavelength of a laser beam not substantially diffracted is λ_{ND}, a refractive index of the high refractive index material at the wavelength λ_{ND} is n_{ND}, a refractive index of the low refractive index material at the wavelength λ_{ND} is n_{LND}, a refractive index of a medium in a space adjacent to the dielectric multilayer film is n_{0ND}, a total thickness of the dielectric film made of the high refractive index material is d_{H}, and a total thickness of the dielectric film made of the low refractive index material is d_{L}, following expressions and are satisfied:
$$\begin{matrix}\frac{0.5 {λ}_{ND}}{( {n}_{HND} - {n}_{0 ND} )} \leq {d}_{H} < \frac{{λ}_{ND}}{( {n}_{HND} - {n}_{0 ND} )} , \\ {d}_{L} \leq \frac{{λ}_{ND} - ( {n}_{HND} - {n}_{0 ND} ) \times {d}_{H}}{( {n}_{LND} - {n}_{0 ND} )} .\end{matrix}$$

7. The grating element according to claim 1, wherein the dielectric multilayer film is formed by alternate lamination of the dielectric film made of a high refractive index material and the dielectric film made of a low refractive index material.

8. The grating element according to claim 1, wherein a reflectivity being a rate that a laser beam incident on the dielectric multilayer film is reflected by the dielectric multilayer film is equal to or lower than 4%.

9. The grating element according to claim 1, wherein, in the diffraction member with the protrusion made of the dielectric multilayer film, when a pitch of a grating structure of the diffraction member is P and a width of the protrusion is W, a following expression is satisfied:
0.5<W/P<1.0.

10. The grating element according to claim 1, wherein the plurality of diffraction members are bonded together by an adhesive material.

11. An optical pickup optical system comprising:
a laser unit including a plurality of laser light sources that emit a plurality of laser beams with different wavelengths as a light source,
wherein the grating element according to claim 1 is placed on an optical path of the laser beams emitted from the laser unit.

12. A method of producing a grating element including a plurality of diffraction members each having a protrusion and a recess arranged periodically on one surface of a transparent substrate, comprising:
laminating the plurality of diffraction members in a substantially perpendicular direction to the transparent substrate;
forming the protrusion of at least one diffraction member of the plurality of diffraction members by a dielectric multilayer film; and
forming the dielectric multilayer film by laminating dielectric films of two or more types in the substantially perpendicular direction on the transparent substrate,
wherein wavelengths of laser beams diffracted at predetermined diffraction efficiencies by the plurality of diffraction members are different from one another.

13. The method of producing the grating element according to claim 12, wherein three diffraction members are laminated in the substantially perpendicular direction.

14. The method of producing the grating element according to claim 12, wherein two diffraction members are laminated in the substantially perpendicular direction.

15. The method of producing the grating element according to claim 12, wherein, in the diffraction member with the protrusion made of the dielectric multilayer film, when a phase shift amount added to a laser beam to be diffracted at the predetermined diffraction efficiency is φ_{D} and a phase shift amount added to a laser beam to be not substantially diffracted is φ_{ND}, following expressions and are satisfied:
0.10<|φ_{D}|≦0.25
0.00≦|φ_{ND}|≦0.10.

16. The method of producing the grating element according to claim 14, wherein, in the diffraction member with the protrusion made of the dielectric multilayer film, when a phase shift amount added to a laser beam to be diffracted at the predetermined diffraction efficiency is φ_{D} and a phase shift amount added to a laser beam to be not substantially diffracted is φ_{ND}, following expressions and are satisfied:
0.10<|φ_{D}|≦0.25
0.00≦φ_{ND}|≦0.10,

17. The method of producing the grating element according to claim 14, wherein
the dielectric multilayer film is formed by laminating the dielectric film made of a high refractive index material and the dielectric film made of a low refractive index material, and
in the diffraction member with the protrusion made of the dielectric multilayer film, when a wavelength of a laser beam diffracted at the predetermined diffraction efficiency is λ_{D}, a wavelength of a laser beam not substantially diffracted is λ_{ND}, a refractive index of the high refractive index material at the wavelength λ_{ND} is n_{HND}, a refractive index of the low refractive index material at the wavelength λ_{ND} is n_{LND}, a refractive index of a medium in a space adjacent to the dielectric multilayer film is n_{0ND}, a total thickness of the dielectric film made of the high refractive index material is d_{H}, and a total thickness of the dielectric film made of the low refractive index material is d_{L}, following expressions and are satisfied:
$$\begin{matrix}\frac{0.5 {λ}_{ND}}{( {n}_{HND} - {n}_{0 ND} )} \leq {d}_{H} < \frac{{λ}_{ND}}{( {n}_{HND} - {n}_{0 ND} )} , \\ {d}_{L} \leq \frac{{λ}_{ND} - ( {n}_{HND} - {n}_{0 ND} ) \times {d}_{H}}{( {n}_{LND} - {n}_{0 ND} )} .\end{matrix}$$

18. The method of producing the grating element according to claim 12, wherein the dielectric multilayer film is formed by alternately laminating the dielectric film made of a high refractive index material and the dielectric film made of a low refractive index material.

19. The method of producing the grating element according to claim 12, wherein a reflectivity being a rate that a laser beam incident on the dielectric multilayer film is reflected by the dielectric multilayer film is equal to or lower than 4%.

20. The method of producing the grating element according to claim 12, wherein, in the diffraction member with the protrusion made of the dielectric multilayer film, when a pitch of a grating structure of the diffraction member is P and a width of the protrusion is W, a following expression is satisfied:
0.5<W/P<1.0.

21. The method of producing the grating element according to claim 12, wherein the plurality of diffraction members are bonded together by an adhesive material.
